(19) United States
(12) Patent Application Publication
(10) Pub. No.: US 2013/0146100 A1
(43) Pub. Date: Jun. 13, 2013

(54) Water Repellent Protective Film Forming Agent, Liquid Chemical for Forming Water Repellent Protective Film, and Wafer Cleaning Method Using Liquid Chemical

(71) Applicant: Central Glass Company, Limited, Ube-shi (JP)

(72) Inventors: Masanori SAITO, Matsusaka-shi (JP); Takashi Saio, Suzaka-shl (JP); Shinobu Arata, Matsusaka-shi (JP); Soichi Kumon, Matsusaka-shi (JP); Hidehisa Nanai, Toshima-ku (JP)

(21) Appl. No.: 13/667,236

(22) Filed: Nov. 2, 2012

Related U.S. Application Data
(63) Continuation of application No. PCT/JP2011/064370, filed on Jun. 23, 2011.

(30) Foreign Application Priority Data
Jun. 28, 2010 (JP) 2010-146655
Feb. 25, 2011 (JP) 2011-040118
May 13, 2011 (JP) 2011-108634

(51) Int. Cl. B08B 3/04; C07F 7/12

(52) U.S. Cl. CPC B08B 3/04; C07F 7/12
USPC 134/26; 556/488; 556/410; 106/2

(57) ABSTRACT

A water repellent protective film forming agent is provided for forming a protective film on a wafer that has an uneven pattern at its surface. The protective film is formed at least on surfaces of recessed portions of the wafer at the time of cleaning the wafer. The wafer is a wafer that contains a material including silicon element at least at the surfaces of the recessed portions of the uneven pattern or a wafer that contains at least one kind of material selected from the group consisting of titanium, titanium nitride, tungsten, aluminum, copper, tin, tantalum nitride and ruthenium at least at a part of the surfaces of the recessed portions of the uneven pattern. The water repellent protective film forming agent is provided to contain a silicon compound represented by the following general formula [1]:

R¹ₐSiX₄₋ₐ [1]

### TECHNICAL FIELD

The present invention relates to a technique of cleaning a substrate wafer in semiconductor device fabrication and the like.

### BACKGROUND OF THE INVENTION

In semiconductor chip fabrication, a silicon wafer is subjected to film formation, lithography, etching and the like so as to be formed having a finely uneven pattern at its surface, and then subjected to cleaning with use of water or an organic solvent in order to make the wafer surface clean. The devices are on the trend toward micro-patterning in order to enlarge the scale of integration, with which intervals among the uneven pattern have been becoming narrower. Accordingly, a problem of collapse of the uneven pattern, which is caused by the capillary action exhibited when cleaning is carried out with use of water and the water is evaporated from the wafer surface or when a gas-liquid interface passes through the pattern, tends to easily occur. This problem is getting serious particularly in semiconductor chips of generations having a line width (the width of the recessed portions) of from the order of 20 nm to the order of 10 nm, in the case where the wafer has narrower intervals of uneven pattern (e.g., a line-and-space type pattern).

As a method of cleaning a wafer surface while preventing the pattern collapse, Patent Publication 1 discloses a method of substituting water remaining on the wafer surface with isopropanol or the like and then drying it. Additionally, in Patent Publication 2, there is disclosed a cleaning method where a water repellent protective film is formed with use of a water-soluble surfactant or a silane coupling agent on a wafer formed of a silicon-based material and provided with an uneven pattern at its surface so as to reduce the capillary force thereby preventing the pattern collapse, and more specifically, a method of forming a water repellent protective film on an unevenly-patterned portion containing silicon after cleaning a wafer surface with water and then conducing rinsing with water and then drying. This protective film is finally removed. Since the patterned portion is provided with water repellency by the protective film, there is exhibited the effect of suppressing the collapse of the uneven pattern at the time of performing rinsing with water. This method is said to have the effect also against a pattern having an aspect ratio of not less than 8.

In Patent Publication 3, a technique of changing a cleaning liquid from water to 2-propanol before a gas-liquid interface passes through the pattern is disclosed as a technique of suppressing the pattern collapse. However, it is said that there are limitations to adaptable patterns, for example, a limitation of an aspect ratio of not higher than 5.

Moreover, in Patent Publication 4, there is disclosed a technique directed to a resist pattern, as a technique of suppressing the pattern collapse. This technique is a technique of decreasing the capillary force to the limit thereby suppressing the pattern collapse. However, the thus disclosed technique is directed toward a resist pattern and aims to reform the resist itself, in other words, not applicable to the use of the present invention. Furthermore, since a treatment agent is finally removable together with the resist, it is not necessary to estimate a technique for removing the treatment agent after drying; therefore this is not applicable to the object of the present invention.

Furthermore, in Patent Publications 5 and 6, there is disclosed a technique of preventing the pattern collapse by performing a hydrophobicity-imparting treatment with use of a treatment agent containing: a sililation reagent represented by N,N-dimethylaminotrimethylsilane; and a solvent.

### REFERENCES ABOUT PRIOR ART

### Patent Publication

Patent Publication 1: Japanese Patent Application Publication No. 2003-45843
Patent Publication 2: Japanese Patent No. 4403202
Patent Publication 3: Japanese Patent Application Publication No. 2008-198958
Patent Publication 4: Japanese Patent Application Publication No. 5-299336
Patent Publication 5: Japanese Patent Application Publication No. 2010-129932
Patent Publication 6: International Application Publication 10/47196 Pamphlet

### DISCLOSURE OF THE INVENTION

### Problems to be Solved by the Invention

The present invention relates to a technique for cleaning a substrate (a wafer) in semiconductor device fabrication and the like, the objective of which is to enhance the production yield of devices having such a circuit pattern as to be particularly fine and high in aspect ratio. Additionally, the present invention relates to a water repellent liquid chemical and the like which liquid chemical aims to improve a cleaning step which tends to induce a wafer having an uneven pattern at its surface to cause an uneven pattern collapse. In the case of aiming to prevent the pattern collapse by imparting water repellency to surfaces of the uneven pattern, in order to form a water repellent protective film on the surfaces of the uneven pattern, it is necessary to bond the active site (such as a hydroxyl group that exists on the unevenly patterned surface or on the wafer surface) to a compound that can form a protective film.

However, the surface of uneven patterns are inherently different in amount of hydroxyl groups with each kind of material, and different in capability forming hydroxyl groups with each condition, for surface treatment using water, acid or the like, so that there sometimes arises a difference in amount of hydroxyl groups per unit area. Furthermore, in recent years, wafers that contain at least one kind of material selected from the group consisting of titanium, titanium nitride, tungsten, aluminum, copper, tin, tantalum nitride and ruthenium has become used together with the diversification of the pattern.

The surface of uneven patterns are inherently different in amount of hydroxyl groups with each kind of material, and different in capability forming hydroxyl groups with each condition for surface treatment using water, acid or the like; hence these factors sometimes bring about a difference in amount of hydroxyl groups per unit area. In addition, the reactivity of hydroxyl group gets different according to atom to be bonded to a hydroxyl group serving as the active site. In the case of using a wafer that contains a material as mentioned above (such as a material having a small amount of hydroxyl groups at the surface, or a material where hydroxyl groups are hardly formed at the surface, or a material of which hydroxyl groups that exist at the surface have a low reactivity) at least at a part of surfaces of recessed portions of the uneven pattern, it is impossible to form a water repellent protective film for preventing the pattern collapse even if any of the treatment liquids and the treatment methods disclosed by Patent Publications 2, 5 and 6 is employed, which is problematic.

In view of the above, an object of the present invention is: to provide a liquid chemical for forming a water repellent protective film (hereinafter, sometimes referred to as “a liquid chemical for forming a protective film” or merely as “a liquid chemical”), the liquid chemical containing a water repellent protective film forming agent (hereinafter, sometimes referred to merely as “a protective film forming agent”) which is able to form a water repellent protective film (hereinafter, sometimes referred to merely as “a protective film”) on a wafer that has an uneven pattern at its surface, the protective film being formed on surfaces of recessed portions of the wafer, the wafer being a wafer that contains silicon element at least at a part of the surfaces of the recessed portions of the uneven pattern or a wafer that contains at least one kind of material selected from the group consisting of titanium, titanium nitride, tungsten, aluminum, copper, tin, tantalum nitride and ruthenium at least at a part of the surfaces of the recessed portions of the uneven pattern (hereinafter, such wafers may generically be referred to merely as “a wafer”); and provide a method for cleaning the wafer, the method being able to improve a cleaning step (which tends to induce the pattern collapse) by forming a protective film on the surfaces of the recessed portions with use of the liquid chemical so as to reduce an interaction between a liquid retained in the recessed portions and the surfaces of the recessed portions.

### Means for Solving the Problems

A pattern collapse is to occur when an gas-liquid interface passes through the pattern at the time of drying a wafer. It is said that the reason thereof is that a difference in height of residual liquid between a part having high aspect ratio and a part having low aspect ratio causes a difference in capillary force that acts on the pattern.

Accordingly, by decreasing the capillary force, it is expected that the difference in capillary force due to the difference in height of residual liquid is so reduced as to resolve the pattern collapse. The magnitude of the capillary force is the absolute value “P” obtained by the equation as shown below. It is expected from this equation that the capillary force can be reduced by decreasing γ or cos θ.

P=2×γ×cos θ/S

(In the equation, γ represents the surface tension of a liquid retained in the recessed portions, θ represents the contact angle of the liquid retained in the recessed portions to the surfaces of the recessed portions, and S represents the width of the recessed portions.)

In order to solve the above-mentioned problems, the present invention focuses a material for the water repellent protective film to be formed on the surfaces of the uneven pattern. More specifically, the present invention forms a protective film with use of such an agent as to provide water repellency effectively even if ease of hydroxyl group formation is different according to kind of uneven pattern or wafer, i.e., with use of the protective film forming agent contained in the liquid chemical, thereby reducing the range of lot-by-lot modification of cleaning conditions to achieve an industrially advantageous cleaning of the wafer. Furthermore, the present invention can effectively impart water repellency to the surfaces of the recessed portions even if the wafer is a wafer that contains a material where the hydroxyl group is hardly formed at the surface or a material of which the hydroxyl group that exists at the surface has a low reactivity at least at a part of the surfaces of the recessed portions of the uneven pattern.

The present inventors had eagerly studied, and attained a finding that a liquid chemical which contains a silicon compound having a specific hydrophobic group is used as a protective film forming agent thereby forming such a protective film as to depend on neither the number of hydroxyl groups that exist on the surfaces of the uneven pattern of the wafer nor the material of the surface of the uneven pattern of the wafer and exhibit an excellent water repellency and a finding that the cleaning of the surfaces of the pattern can be achieved efficiently thereby.

Hydrophobic group discussed in the present invention means a unsubstituted hydrocarbon group or a hydrocarbon group where a part of hydrogen elements in the hydrocarbon group is substituted with a halogen element(s). The hydrophobicity of the hydrophobic group becomes stronger with increase of carbon number in the hydrocarbon group. Furthermore, in the case of a hydrocarbon group where a part of hydrogen elements in the hydrocarbon group is substituted with a halogen element(s), the hydrophobicity of the hydrophobic group sometimes becomes strong. When the halogen element used for substitution is fluorine element, the hydrophobicity of the hydrophobic group becomes much stronger. The more the number of substituted fluorine elements is, the stronger the hydrophobicity of the hydrophobic group becomes.

In other words, the present invention is to provide inventions as discussed in the following [Invention 1] to [Invention 14].

[Invention 1]

A water repellent protective film forming agent which is able to form a protective film on a wafer that has an uneven pattern at its surface, the protective film being formed at least on surfaces of recessed portions of the wafer at the time of cleaning the wafer, the wafer being a wafer that contains a material including silicon element at least at the surfaces of the recessed portions of the uneven pattern or a wafer that contains at least one kind of material selected from the group consisting of titanium, titanium nitride, tungsten, aluminum, copper, tin, tantalum nitride and ruthenium at least at a part of the surfaces of the recessed portions of the uneven pattern, the agent comprising a silicon compound represented by the following general formula [1].

R¹ₐSiX₄₋ₐ [1]

[In the formula, R¹ mutually independently represents hydrogen group or a C₁-C₁₈ hydrocarbon group which is unsubstituted or substituted with halogen atom, and the total number of carbons in mutually independent R¹ is not smaller than 6. X mutually independently represents at least one group selected from: monovalent functional groups of which element to be bonded to silicon element is nitrogen; monovalent functional groups of which element to be bonded to silicon element is oxygen; and halogen groups. “a” is an integer of from 1 to 3.]

[Invention 2]

A water repellent protective film forming agent which is able to form a protective film on a wafer that has an uneven pattern at its surface, the protective film being formed at least on surfaces of recessed portions of the wafer at the time of cleaning the wafer, the wafer being a wafer that contains silicon nitride at least at the surfaces of the recessed portions of the uneven pattern, the agent comprising a silicon compound represented by the following general formula [1].

R¹ₐSiX₄₋ₐ [1]

[In the formula, R¹ mutually independently represents hydrogen group or a C₁-C₁₈ hydrocarbon group which is unsubstituted or substituted with halogen atom, and the total number of carbons in mutually independent R¹ is not smaller than 6. X mutually independently represents at least one group selected from: monovalent functional groups of which element to be bonded to silicon element is nitrogen; monovalent functional groups of which element to be bonded to silicon element is oxygen; and halogen groups. “a” is an integer of from 1 to 3.]

[Invention 3]

A water repellent protective film forming agent which is able to form a protective film on a wafer that has an uneven pattern at its surface, the protective film being formed at least on surfaces of recessed portions of the wafer at the time of cleaning the wafer, the wafer being a wafer that contains at least one kind of material selected from the group consisting of titanium, titanium nitride, tungsten, aluminum, copper, tin, tantalum nitride and ruthenium at least at the surfaces of the recessed portions of the uneven pattern, the agent comprising a silicon compound represented by the following general formula [1].

R¹ₐSiX₄ₐ [1]

[In the formula, R¹ mutually independently represents hydrogen group or a C₁-C₁₈ hydrocarbon group which is unsubstituted or substituted with halogen atom, and the total number of carbons in mutually independent R¹ is not smaller than 6. X mutually independently represents at least one group selected from: monovalent functional groups of which element to be bonded to silicon element is nitrogen; monovalent functional groups of which element to be bonded to silicon element is oxygen; and halogen groups. “a” is an integer of from 1 to 3.]

[Invention 4]

A water repellent protective film forming agent as discussed in any of Inventions 1 to 3, wherein the silicon compound represented by the general formula [1] is represented by the following general formula [4].

R³ₐR⁴_{b}SiX_{4-a-b} [4]

[In the formula, R³ mutually independently represents a C₁-C₁₈ hydrocarbon group where one or more hydrogen elements are substituted with a fluorine element(s). R⁴ mutually independently represents hydrogen group or a C₁-C₁₈ hydrocarbon group. The total number of carbons in R³ and R⁴ in the general formula [4] is not smaller than 6. X mutually independently represents at least one group selected from: monovalent functional groups of which element to be bonded to silicon element is nitrogen; monovalent functional groups of which element to be bonded to silicon element is oxygen; and halogen groups. “a” is an integer of from 1 to 3, “b” is an integer of from 0 to 2, and the total of “a” and “b” is 1 to 3.]

[Invention 5]

A water repellent protective film forming agent as discussed in any of Inventions 1 to 3, wherein the silicon compound represented by the general formula [1] is represented by the following general formula [2].

R¹₃SiX [2]

[In the formula, both of R¹ and X are identical with those of the general formula [1].]

[Invention 6]

A water repellent protective film forming agent as discussed in any of Inventions 1 to 3, wherein the silicon compound represented by the general formula [1] is represented by the following general formula [3].

R²(CH₃)₂SiX [3]

[In the formula, R² represents a C₄-C₁₈ hydrocarbon group which is unsubstituted or substituted with halogen atom. X is identical with that of the general formula [1].]

[Invention 7]

A water repellent protective film forming agent as discussed in any of Inventions 1 to 6, wherein R¹, R² or R³ in the silicon compound includes five or more fluorine atoms.

[Invention 8]

A liquid chemical for forming a water repellent protective film, comprising a water repellent protective film forming agent as discussed in any of Inventions 1 to 7.

[Invention 9]

A liquid chemical for forming a water repellent protective film, as discussed in Invention 8, further comprising acid.

[Invention 10]

A liquid chemical for forming a water repellent protective film, as discussed in Invention 8 or 9, wherein the content of the water repellent protective film forming agent relative to 100 mass % of the total amount of the liquid chemical for forming a water repellent protective film is 0.1 to 50 mass %.

[Invention 11]

A method for cleaning a wafer that has an uneven pattern at its surface, the wafer being a wafer that contains a material including silicon element at least at surfaces of recessed portions of the uneven pattern or a wafer that contains at least one kind of material selected from the group consisting of titanium, titanium nitride, tungsten, aluminum, copper, tin, tantalum nitride and ruthenium at least at a part of the surfaces of the recessed portions of the uneven pattern, the method comprising the following steps of:

a cleaning step using a water-based cleaning liquid, where the surface of the wafer is cleaned with a water-based cleaning liquid;

a water repellent protective film forming step where a liquid chemical for forming a water repellent protective film is retained at least in the recessed portions of the wafer thereby forming a water repellent protective film on the surfaces of the recessed portions;

a liquid removal step where a liquid on the surface of the wafer is removed; and

a water repellent protective film removal step where the water repellent protective film is removed from the surfaces of the recessed portions,

wherein a liquid chemical for forming a water repellent protective film, as discussed in any of Inventions 8 to 10 is used in the water repellent protective film forming step.

[Invention 12]

A method for cleaning a wafer, as discussed in Invention 11, wherein the wafer is a wafer that contains silicon nitride at least at the surfaces of the recessed portions of the uneven pattern.

[Invention 13]

A method for cleaning a wafer, as discussed in Invention 11, wherein the wafer is a wafer that contains at least one kind of material selected from the group consisting of titanium, titanium nitride, tungsten, aluminum, copper, tin, tantalum nitride and ruthenium at least at the surfaces of the recessed portions of the uneven pattern.

[Invention 14]

A method for cleaning a wafer, as discussed in any of Inventions 11 to 13, wherein the water repellent protective film removal step is performed by at least one treatment method selected from: irradiating the surface of the wafer with light; heating the wafer; irradiating the surface of the wafer with plasma; exposing the surface of the wafer to ozone; and subjecting the wafer to corona discharge.

In the present invention, “a water repellent protective film” means a film formed at least on the surfaces of the recessed portions of the uneven pattern so as to reduce the wettability of the wafer surface, in other words, a film imparting water repellency. In the present invention, “water repellency” means a reduction of a surface energy of an article surface thereby weakening the interaction between water or another liquid and the article surface (i.e., at the interface), such as hydrogen bond, intermolecular forces and the like. The effect of reducing the interaction is particularly outstanding against water, but this effect is exhibited also against a mixed liquid of water and a liquid other than water, or against a liquid other than water. With the reduction of the interaction, it becomes possible to increase the contact angle of the liquid to the article surface.

### Effects of the Invention

In the process of cleaning a wafer, by using the water repellent protective film forming agent of the present invention, a protective film exhibiting an excellent water repellency is formed in the process of cleaning a wafer, and this contributes to reduction of dependence on the number of hydroxyl groups that exist on the surface of the uneven pattern. The application of the present invention accomplishes a stable cleaning of wafers while preventing the collapse of the uneven pattern and contributes to reduction of lot-by-lot modification in cleaning condition.

Additionally, when the cleaning method of the present invention is employed, a cleaning step conducted in a method for producing a wafer that has an uneven pattern at its surface is improved without lowering throughput. Accordingly, the above-mentioned cleaning method and a method for producing a wafer that has an uneven pattern at its surface, which is conducted by using the liquid chemical, is excellent in productivity. Furthermore, the present invention is also applicable to cleaning of a variety of wafers (different in material of the surface) and therefore contributes to reduction of modification in cleaning condition according to the kind of the wafers.

### BRIEF EXPLANATION OF THE DRAWINGS

FIG. 1 A schematic plan view of a wafer 1 whose surface is made into a surface having an uneven pattern 2.

FIG. 2 A view showing a part of a-a′ cross section of FIG. 1.

FIG. 3 A schematic view showing a condition where a liquid chemical 8 for forming a water repellent protective film is retained in recessed portions 4.

FIG. 4 A schematic view showing a condition where a liquid 9 is retained in the recessed portions 4 on which a water repellent protective film 10 is formed.

### EMBODIMENTS FOR CARRYING OUT THE INVENTION

Hereinafter, the present invention will be discussed. First of all, a water repellent protective film forming agent provided by the present invention is a water repellent protective film forming agent which is able to form a water repellent protective film on a wafer that has an uneven pattern at its surface, the protective film being formed at least on surfaces of recessed portions of the wafer at the time of cleaning the wafer, the wafer being a wafer that contains a material including silicon element at least at the surfaces of the recessed portions of the uneven pattern or a wafer that contains at least one kind of material selected from the group consisting of titanium, titanium nitride, tungsten, aluminum, copper, tin, tantalum nitride and ruthenium at least at a part of the surfaces of the recessed portions of the uneven pattern, the agent comprising a silicon compound represented by the following general formula [1].

R¹ₐSiX₄₋ₐ [1]

[In the formula, R¹ mutually independently represents hydrogen group or a C₁-C₁₈ hydrocarbon group which is unsubstituted or substituted with halogen atom, and the total number of carbons in mutually independent R¹, is not smaller than 6. X mutually independently represents at least one group selected from: monovalent functional groups of which element to be bonded to silicon element is nitrogen; monovalent functional groups of which element to be bonded to silicon element is oxygen; and halogen groups. “a” is an integer of from 1 to 3.]

For example, silicon oxide has at its surface an abundance of hydroxyl group (silanol group) that serves as an active site; however, in general, materials such as silicon nitride, polysilicon, titanium, titanium nitride, tungsten, aluminum, copper, tin, tantalum nitride, ruthenium and the like have difficulty in forming hydroxyl group at its surface and additionally the resident hydroxyl groups are low in reactivity. Even if a conventional silane coupling agent is reacted with such few or low reactive hydroxyl groups, it is difficult to impart a sufficient water repellency to the surface. However, if hydrophobic group is a group exhibiting a strong hydrophobicity, an excellent water repellency can be provided.

A hydrocarbon group represented by R¹ in the above-mentioned silicon compound is a hydrophobic group, so that if the protective film is formed by using a bulky hydrophobic group the surface of the wafer exhibits a good water repellency after being subjected to a treatment. When the total number of carbons in R¹ is not smaller than 6, a water repellent film exhibiting a sufficient water repellent performance can be produced even if the number of hydroxyl groups per unit area of the wafer is low.

As a silicon compound represented by the general formula [1], it is possible to cite chlorosilane-based compounds such as C₄H₉(CH₃)₂SiCl, C₅H₁₁(CH₃)₂SiCl, C₆H₁₃(CH₃)₂SiCl, C₇H₁₅(CH₃)₂SiCl, C₈H₁₇(CH₃)₂SiCl, C₉H₁₉(CH₃)₂SiCl, C₁₀H₂₁(CH₃)₂SiCl, C₁₁H₂₃(CH₃)₂SiCl, C₁₂H₂₅(CH₃)₂SiCl, C₁₃H₂₇(CH₃)₂SiCl, C₁₄H₂₉(CH₃)₂SiCl, C₁₅H₃₁(CH₃)₂SiCl, C₁₆H₃₃(CH₃)₂SiCl, C₁₇H₃₅(CH₃)₂SiCl, C₁₈H₃₇(CH₃)₂SiCl, C₅H₁₁(CH₃)HsiCl, C₆H₁₃(CH₃)HsiCl, C₇H₁₅(CH₃)HsiCl, C₈H₁₇(CH₃)HsiCl, C₉H₁₉(CH₃)HsiCl, C₁₀H₂₁(CH₃)HsiCl, C₁₁H₂₃(CH₃)HsiCl, C₁₂H₂₅(CH₃)HsiCl, C₁₃H₂₇(CH₃)HsiCl, C₁₄H₂₉(CH₃)HsiCl, C₁₅H₃₁(CH₃)HsiCl, C₁₆H₃₃(CH₃)HsiCl, C₁₇H₃₅(CH₃)HsiCl, C₁₈H₃₇(CH₃)HsiCl, C₂F₅C₂H₄(CH₃)₂SiCl, C₃F₇C₂H₄(CH₃)₂SiCl, C₄F₉C₂F₄(CH₃)₂SiCl, C₅F₁₁C₂H₄(CH₃)₂SiCl, C₆F₁₃C₂H₄(CH₃)₂SiCl, C₇F₁₅C₂H₄(CH₃)₂SiCl, C₈F₁₇C₂H₄(CH₃)₂SiCl, (C₂H₅)₃SiCl, C₃H₇(C₂H₅)₂SiCl, C₄H₉(C₂H₅)₂SiCl, C₅H₁₁(C₂H₅)₂SiCl, C₆H₁₃(C₂H₅)₂SiCl, C₇H₁₅(C₂H₅)₂SiCl, C₈H₁₇(C₂H₅)₂SiCl, C₉H₁₉(C₂H₅)₂SiCl, C₁₀H₂₁(C₂H₅)₂SiCl, C₁₁H₂₃(C₂H₅)₂SiCl, C₁₂H₂₅(C₂H₅)₂SiCl, C₁₃H₂₄C₂H₅)₂SiCl, C₁₄H₂₉(C₂H₅)₂SiCl, C₁₅H₃₁(C₂H₅)₂SiCl, C₁₆H₃₃(C₂H₅)₂SiCl, C₁₇H₃₅(C₂H₅)₂SiCl, C₁₈H₃₇(C₂H₅)₂SiCl, (C₄H₉)₃SiCl, C₅H₁₁(C₄H₉)₂SiCl, C₆H₁₃(C₄H₉)₂SiCl, C₇H₁₅(C₄H₉)₂SiCl, C₈H₁₇(C₄H₉)₂SiCl, C₉H₁₉(C₄H₉)₂SiCl, C₁₀H₂₁(C₄H₉)₂SiCl, C₁₁H₂₃(C₄H₉)₂SiCl, C₁₂H₂₅(C₄H₉)₂SiCl, C₁₃H₂₇(C₄H₉)₂SiCl, C₁₄H₂₉(C₄H₉)₂SiCl, C₁₅H₃₁(C₄H₉)₂SiCl, C₁₆H₃₃(C₄H₉)₂SiCl, C₁₇H₃₅(C₄H₉)₂SiCl, C₁₈H₃₇(C₄H₉)₂SiCl, CF₃C₂H₄(C₄H₉)₂SiCl, C₂F₅C₂H₄(C₄H₉)₂SiCl, C₃F₇C₂H₄(C₄H₉)₂SiCl, C₄F₉C₂H₄(C₄H₉)₂SiCl, C₅F₁₁C₂H₄(C₄H₉)₂SiCl, C₆F₁₃C₂H₄(C₄H₉)₂SiCl, C₇F₁₅C₂H₄(C₄H₉)₂SiCl, C₈F₁₇C₂H₄(C₄H₉)₂SiCl, C₅H₁₁(CH₃)SiCl₂, C₆H₁₃(CH₃)SiCl₂, C₇H₁₅(CH₃)SiCl₂, C₈H₁₇(CH₃)SiCl₂, C₉H₁₉(CH₃)SiCl₂, C₁₀H₂₁(CH₃)SiCl₂, C₁₁H₂₃(CH₃)SiCl₂, C₁₂H₂₅(CH₃)SiCl₂, C₁₃H₂₇(CH₃)SiCl₂, C₁₄H₂₉(CH₃)SiCl₂, C₁₅H₃₁(CH₃)SiCl₂, C₁₆H₃₃(CH₃)SiCl₂, C₁₇H₃₅(CH₃)SiCl₂, C₁₈H₃₇(CH₃)SiCl₂, C₃F₇C₂H₄(CH₃)SiCl₂, C₄F₉C₂H₄(CH₃)SiCl₂, C₅F₁₁C₂H₄(CH₃)SiCl₂, C₆F₁₃C₂H₄(CH₃)SiCl₂, C₇H₁₅C₂H₄(CH₃)SiCl₂, C₈F₁₇C₂H₄(CH₃)SiCl₂, C₆H₁₃SiCl₃, C₇H₁₅SiCl₃, C₈H₁₇SiCl₃, C₉H₁₉SiCl₃, C₁₀H₂₁SiCl₃, C₁₁H₂₃SiCl₃, C₁₂H₂₅SiCl₃, C₁₃H₂₇SiCl₃, C₁₄H₂₉SiCl₃, C₁₅H₃₁SiCl₃, C₁₆H₃₃SiCl₃, C₁₇H₃₅SiCl₃, C₁₈H₃₇SiCl₃, C₄F₉C₂H₄SiCl₃, C₅F₁₁C₂H₄SiCl₃, C₆F₁₃C₂H₄SiCl₃, C₇F₁₅C₂H₄SiCl₃, C₈F₁₇C₂H₄SiCl₃ and the like, for example.

In addition, it is also possible to cite alkoxysilane-based compounds such as C₄H₉(CH₃)₂SiOCH₃, C₅H₁₁(CH₃)₂SiOCH₃, C₆H₁₃(CH₃)₂SiOCH₃, C₇H₁₅(CH₃)₂SiOCH₃, C₈H₁₇(CH₃)₂SiOCH₃, C₉H₁₉(CH₃)₂SiOCH₃, C₁₀H₂₁(CH₃)₂SiOCH₃, C₁₁H₂₃(CH₃)₂SiOCH₃, C₁₂H₂₅(CH₃)₂SiOCH₃, C₁₃H₂₇(CH₃)₂SiOCH₃, C₁₄H₂₉(CH₃)₂SiOCH₃, C₁₅H₃₁(CH₃)₂SiOCH₃, C₆H₃₃(CH₃)₂SiOCH₃, C₁₇H₃₅(CH₃)₂SiOCH₃, C₁₈H₃₇(CH₃)₂SiOCH₃, C₅H₁₁(CH₃)HSiOCH₃, C₆H₁₃(CH₃)HSiOCH₃, C₇H₁₅(CH₃)HSiOCH₃, C₈H₁₇(CH₃)HSiOCH₃, C₉H₁₉(CH₃)HSiOCH₃, C₁₀H₂₁(CH₃)HSiOCH₃, C₁₁H₂₃(CH₃)HSiOCH₃, C₁₂H₂₅(CH₃)HSiOCH₃, C₁₃H₂₇(CH₃)HSiOCH₃, C₁₄H₂₉(CH₃)HSiOCH₃, C₁₅H₃₁(CH₃)HSiOCH₃, C₁₆H₃₃(CH₃)HSiOCH₃, C₁₇H₃₅(CH₃)HSiOCH₃, C₁₈H₃₇(CH₃)HSiOCH₃, C₂F₅C₂H₄(CH₃)₂SiOCH₃, C₃F₇C₂H₄(CH₃)₂SiOCH₃, C₄F₉C₂H₄(CH₃)₂SiOCH₃, C₅F₁₁C₂H₄(CH₃)₂SiOCH₃, C₆F₁₃C₂H₄(CH₃)₂SiOCH₃, C₇F₁₅C₂H₄(CH₃)₂SiOCH₃, C₈F₁₇C₂H₄(CH₃)₂SiOCH₃, (C₂H₅)₃SiOCH₃, C₃H₇(C₂H₅)₂SiOCH₃, C₄H₉(C₂H₅)₂SiOCH₃, C₅H₁₁(C₂H₅)₂SiOCH₃, C₆H₁₃(C₂H₅)₂SiOCH₃, C₇H₁₅(C₂H₅)₂SiOCH₃, C₈H₁₇(C₂H₅)₂SiOCH₃, C₉H₁₉(C₂H₅)₂SiOCH₃, C₁₀H₂₁(C₂H₅)₂SiOCH₃, C₁₁H₂₃(C₂H₅)₂SiOCH₃, C₁₂H₂₅(C₂H₅)₂SiOCH₃, C₁₃H₂₇(C₂H₅)₂SiOCH₃, C₁₄H₂₉(C₂H₅)₂SiOCH₃, C₁₅H₃₁(C₂H₅)₂SiOCH₃, C₁₆H₃₃(C₂H₅)₂SiOCH₃, C₁₇H₃₅(C₂H₅)₂SiOCH₃, C₁₈H₃₇(C₂H₅)₂SiOCH₃, (C₄H₉)₃SiOCH₃, C₅H₁₁(C₄H₉)₂SiOCH₃, C₆H₁₃(C₄H₉)₂SiOCH₃, C₇H₁₅(C₄H₉)₂SiOCH₃, C₈H₁₇(C₄H₉)₂SiOCH₃, C₉H₁₉(C₄H₉)₂SiOCH₃, C₁₀H₂₁(C₄H₉)₂SiOCH₃, C₁₁H₂₃(C₄H₉)₂SiOCH₃, C₁₂H₂₅(C₄H₉)₂SiOCH₃, C₁₃H₂₇(C₄H₉)₂SiOCH₃, C₁₄H₂₉(C₄H₉)₂SiOCH₃, C₁₅H₃₁(C₄H₉)₂SiOCH₃, C₁₆H₃₃(C₄H₉)₂SiOCH₃, C₁₇H₃₅(C₄H₉)₂SiOCH₃, C₁₈H₃₇(C₄H₉)₂SiOCH₃, C₅H₁₁(CH₃)Si(OCH₃)₂, C₆H₁₃(CH₃)Si(OCH₃)₂, C₇H₁₅(CH₃)Si(OCH₃)₂, C₈H₁₇(CH₃)Si(OCH₃)₂, C₉H₁₉(CH₃)Si(OCH₃)₂, C₁₀H₂₁(CH₃)Si(OCH₃)₂, C₁₁H₂₃(CH₃)Si(OCH₃)₂, C₁₂H₂₅(CH₃)Si(OCH₃)₂, C₁₃H₂₇(CH₃)Si(OCH₃)₂, C₁₄H₂₉(CH₃)Si(OCH₃)₂, C₁₅H₃₁(CH₃)Si(OCH₃)₂, C₁₆H₃₃(CH₃)Si(OCH₃)₂, C₁₇H₃₅(CH₃)Si(OCH₃)₂, C₁₈H₃₇(CH₃)Si(OCH₃)₂, C₃F₇C₂H₄(CH₃)Si(OCH₃)₂, C₄F₉C₂H₄(CH₃)Si(OCH₃)₂, C₅F₁₁C₂H₄(CH₃)Si(OCH₃)₂, C₆F₁₃C₂H₄(CH₃)Si(OCH₃)₂, C₇F₁₅C₂H₄(CH₃)Si(OCH₃)₂, C₈F₁₇C₂H₄(CH₃)Si(OCH₃)₂, C₆H₁₃Si(OCH₃)₃, C₇H₁₅Si(OCH₃)₃, C₈H₁₇Si(OCH₃)₃, C₉H₁₉Si(OCH₃)₃, C₁₀H₂₁Si(OCH₃)₃, C₁₁H₂₃Si(OCH₃)₃, C₁₂H₂₅Si(OCH₃)₃, C₁₃H₂₇Si(OCH₃)₃, C₁₄H₂₉Si(OCH₃)₃, C₁₅H₃₁Si(OCH₃)₃, C₁₆H₃₃Si(OCH₃)₃, C₁₇H₃₅Si(OCH₃)₃, C₁₈H₃₇Si(OCH₃)₃, C₄F₉C₂H₄Si(OCH₃)₃, C₅F₁₁C₂H₄Si(OCH₃)₃, C₆F₁₃C₂H₄Si(OCH₃)₃, C₇F₁₅C₂H₄Si(OCH₃)₃, C₈F₁₇C₂H₄Si(OCH₃)₃, C₄H₉(CH₃)₂SiOC₂H₅, C₅H₁₁(CH₃)₂SiOC₂H₅, C₆H₁₃(CH₃)₂SiOC₂H₅, C₇H₁₅(CH₃)₂SiOC₂H₅, C₈H₁₇(CH₃)₂SiOC₂H₅, C₉H₁₉(CH₃)₂SiOC₂H₅, C₁₀H₂₁(CH₃)₂SiOC₂H₅, C₁₁H₂₃(CH₃)₂SiOC₂H₅, C₁₂H₂₅(CH₃)₂SiOC₂H₅, C₁₃H₂₇(CH₃)₂SiOC₂H₅, C₁₄H₂₉(CH₃)₂SiOC₂H₅, C₁₅H₃₁(CH₃)₂SiOC₂H₅, C₁₆H₃₃(CH₃)₂SiOC₂H₅, C₁₇H₃₅(CH₃)₂SiOC₂H₅, C₁₈H₃₇(CH₃)₂SiOC₂H₅, C₂F₅C₂H₄(CH₃)₂SiOC₂H₅, C₃F₇C₂H₄(CH₃)₂SiOC₂H₅, C₄F₉C₂H₄(CH₃)₂SiOC₂H₅, C₅F₅C₂H₄(CH₃)₂SiOC₂H₅, C₆F₁₃C₂H₄(CH₃)₂SiOC₂H₅, C₇F₁₅C₂H₄(CH₃)₂SiOC₂H₅, C₈F₁₇C₂H₄(CH₃)₂SiOC₂H₅, (C₂H₅)₃SiOC₂H₅, C₃H₇(C₂H₅)₂SiOC₂H₅, C₄H₉(C₂H₅)₂SiOC₂H₁₅, C₅H₁₁(C₂H₅)₂SiOC₂H₅, C₆H₁₃(C₂H₅)₂SiOC₂H₅, C₇H₁₅(C₂H₅)₂SiOC₂H₁₅, C₈H₁₇(C₂H₅)₂SiOC₂H₅, C₉H₁₉(C₂H₅)₂SiOC₂H₅, C₁₀H₂₁(C₂H₅)₂SiOC₂H₅, C₁₁H₂₃(C₂H₅)₂SiOC₂H₅, C₁₂H₂₅(C₂H₅)₂SiOC₂H₅, C₁₃H₂₇(C₂H₅)₂SiOC₂H₅, C₁₄H₂₉(C₂H₅)₂SiOC₂H₅, C₁₅H₃₁(C₂H₅)₂SiOC₂H₅, C₁₆H₃₃(C₂H₅)₂SiOC₂H₅, C₁₇H₃₅(C₂H₅)₂SiOC₂H₅, C₁₈H₁₃₇(C₂H₅)₂SiOC₂H₅, (C₄H₉)₃SiOC₂H₅, C₅H₁₁(C₄H₉)₂SiOC₂H₅, C₆H₁₃(C₄H₉)₂SiOC₂H₅, C₇H₁₅(C₄H₉)₂SiOC₂H₅, C₈H₁₇(C₄H₉)₂SiOC₂H₅, C₉H₁₉(C₄H₉)₂SiOC₂H₅, C₁₀H₂₁(C₄H₉)₂SiOC₂H₅, C₁₁H₂₃(C₄H₉)₂SiOC₂H₅, C₁₂H₂₅(C₄H₉)₂SiOC₂H₅, C₁₃H₂₇(C₄H₉)₂SiOC₂H₅, C₁₄H₂₉(C₄H₉)₂SiOC₂H₅, C₁₅H₃₁(C₄H₉)₂SiOC₂H₅, C₁₆H₃₃(C₄H₉)₂SiO₂H₅, C₁₇H₃₅(C₄H₉)₂SiOC₂H₅, C₁₈H₃₇(C₄H₉)₂SiOC₂H₅, C₅H₁₁(CH₃)Si(OC₂H₅)₂, C₆H₁₃(CH₃)Si(OC₂H₅)₂, C₇H₁₅(CH₃)Si(OC₂H₅)₂, C₈H₁₇(CH₃)Si(OC₂H₅)₂, C₉H₁₉(CH₃)Si(OC₂H₅)₂, C₁₀H₂₁(CH₃)Si(OC₂H₅)₂, C₁₁H₂₃(CH₃)Si(OC₂H₅)₂, C₁₂H₂₅(CH₃)Si(OC₂H₅)₂, C₁₃H₂₇(CH₃)Si(OC₂H₅)₂, C₁₄H₂₉(CH₃)Si(OC₂H₅)₂, C₁₅H₃₁(CH₃)Si(OC₂H₅)₂, C₁₆H₃₃(CH₃)Si(OC₂H₅)₂, C₁₇H₃₅(CH₃)Si(OC₂H₅)₂, C₁₈H₃₇(CH₃)Si(OC₂H₅)₂, C₃F₇C₂H₄(CH₃)Si(OC₂H₅)₂, C₄F₉C₂H₄(CH₃)Si(OC₂H₅)₂, C₅F₁₁C₂H₄(CH₃)Si(OC₂H₅)₂, C₆F₁₃C₂H₄(CH₃)Si(OC₂H₅)₂, C₇F₁₅C₂H₄(CH₃)Si(OC₂H₅)₂, C₈F₁₇C₂H₄(CH₃)Si(OC₂H₅)₂, C₆H₁₃Si(OC₂H₅)₃, C₇H₁₅Si(OC₂H₅)₃, C₈H₁₇Si(OC₂H₅)₃, C₉H₁₉Si(OC₂H₅)₃, C₁₀H₂₁Si(OC₂H₅)₃, C₁₁H₂₃Si(OC₂H₅)₃, C₁₂H₂₅Si(OC₂H₅)₃, C₁₃H₂₇Si(OC₂H₅)₃, C₁₄H₂₉Si(OC₂H₅)₃, C₁₅H₃₁Si(OC₂H₅)₃, C₁₆H₃₃Si(OC₂H₅)₃, C₁₇H₃₅Si(OC₂H₅)₃, C₁₈H₃₇Si(OC₂H₅)₃, C₄F₉C₂H₄Si(OC₂H₅)₃, C₅F₁₁C₂H₄Si(OC₂H₁₅)₃, C₆F₁₃C₂H₄Si(OC₂H₁₅)₃, C₇F₁₅C₂H₄Si(OC₂H₅)₃, C₈F₁₇C₂H₄Si(OC₂H₅)₃ and the like, for example.

In addition, it is also possible to cite isocyanate silane-based compounds such as C₄H₉(CH₃)₂SiNCO, C₅H₁₁(CH₃)₂SiNCO, C₆H₁₃(CH₃)₂SiNCO, C₇H₁₅(CH₃)₂SiNCO, C₈H₁₇(CH₃)₂SiNCO, C₉H₁₉(CH₃)₂SiNCO, C₁₀H₂₁(CH₃)₂SiNCO, C₁₁H₂₃(CH₃)₂SiNCO, C₁₂H₂₅(CH₃)₂SiNCO, C₁₃H₂₇(CH₃)₂SiNCO, C₁₄H₂₉(CH₃)₂SiNCO, C₁₅H₃₁(CH₃)₂SiNCO, C₁₆H₃₃(CH₃)₂SiNCO, C₁₇H₃₅(CH₃)₂SiNCO, C₁₈H₃₇(CH₃)₂SiNCO, C₂F₅C₂H₄(CH₃)₂SiNCO, C₃F₇C₂H₄(CH₃)₂SiNCO, C₄F₉C₂H₄(CH₃)₂SiNCO, C₅F₁₁C₂H₄(CH₃)₂SiNCO, C₆F₁₃C₂H₄(CH₃)₂SiNCO, C₇F₁₅C₂H₄(CH₃)₂SiNCO, C₈F₁₇C₂H₄(CH₃)₂SiNCO, (C₂H₅)₃SiNCO, C₃H₇(C₂H₅)₂SiNCO, C₄H₉(C₂H₅)₂SiNCO, C₅H₁₁(C₂H₅)₂SiNCO, C₆H₁₃(C₂H₅)₂SiNCO, C₇H₁₅(C₂H₅)₂SiNCO, C₈H₁₇(C₂H₅)₂SiNCO, C₉H₁₉(C₂H₅)₂SiNCO, C₁₀H₂₁(C₂H₅)₂SiNCO, C₁₁H₂₃(C₂H₅)₂SiNCO, C₁₂H₂₅(C₂H₅)₂SiNCO, C₁₃H₂₇(C₂H₅)₂SiNCO, C₁₄H₂₉(C₂H₅)₂SiNCO, C₁₅H₃₁(C₂H₅)₂SiNCO, C₁₆H₃₃(C₂H₅)₂SiNCO, C₁₇H₃₅(C₂H₅)₂SiNCO, C₁₈H₃₇(C₂H₅)₂SiNCO, (C₄H₉)₃SiNCO, C₅H₁₁(C₄H₉)₂SiNCO, C₆H₁₃(C₄H₉)₂SiNCO, C₇H₁₅(C₄H₉)₂SiNCO, C₈H₁₇(C₄H₉)₂SiNCO, C₉H₁₉(C₄H₉)₂SiNCO, C₁₀H₂₁(C₄H₉)₂SiNCO, C₁₁H₂₃(C₄H₉)₂SiNCO, C₁₂H₂₅(C₄H₉)₂SiNCO, C₁₃H₂₇(C₄H₉)₂SiNCO, C₁₄H₂₉(C₄H₉)₂SiNCO, C₁₅H₃₁(C₄H₉)₂SiNCO, C₁₆H₃₃(C₄H₉)₂SiNCO, C₁₇H₃₅(C₄H₉)₂SiNCO, C₁₈H₃₇(C₄H₉)₂SiNCO, C₅H₁₁(CH₃)Si(NCO)₂, C₆H₁₃(CH₃)Si(NCO)₂, C₇H₁₅(CH₃)Si(NCO)₂, C₈H₁₇(CH₃)Si(NCO)₂, C₉H₁₉(CH₃)Si(NCO)₂, C₁₀H₂₁(CH₃)Si(NCO)₂, C₁₁H₂₃(CH₃)Si(NCO)₂, C₁₂H₂₅(CH₃)Si(NCO)₂, C₁₃H₂₇(CH₃)Si(NCO)₂, C₁₄H₂₉(CH₃)Si(NCO)₂, C₁₅H₃₁(CH₃)Si(NCO)₂, C₁₆H₁₃₃(CH₃)Si(NCO)₂, C₁₇H₃₅(CH₃)Si(NCO)₂, C₁₈H₃₇(CH₃)Si(NCO)₂, C₃F₇C₂H₄(CH₃)Si(NCO)₂, C₄F₉C₂H₄(CH₃)Si(NCO)₂, C₅F₁₁C₂H₄(CH₃)Si(NCO)₂, C₆F₁₃C₂H₄(CH₃)Si(NCO)₂, C₇H₁₅C₂H₄(CH₃)Si(NCO)₂, C₈F₁₇C₂H₄(CH₃)Si(NCO)₂, C₆H₁₃Si(NCO)₃, C₇H₁₅Si(NCO)₃, C₈H₁₇Si(NCO)₃, C₉H₁₉Si(NCO)₃, C₁₀H₂₁Si(NCO)₃, C₁₁H₂₃Si(NCO)₃, C₁₂H₂₅Si(NCO)₃, C₁₃H₂₇Si(NCO)₃, C₁₄H₂₉Si(NCO)₃, C₁₅H₃₁Si(NCO)₃, C₁₆H₃₃Si(NCO)₃, C₁₇H₃₅Si(NCO)₃, C is H₃₇Si(NCO)₃, C₄F₉C₂H₄Si(NCO)₃, C₅F₁₁C₂H₄Si(NCO)₃, C₆F₁₃C₂H₄Si(NCO)₃, C₇F₁₅C₂H₄Si(NCO)₃, C₈F₁₇C₂H₄Si(NCO)₃ and the like, for example.

In addition, it is also possible to cite aminosilane-based compounds such as C₄H₉(CH₃)₂SiNH₂, C₅H₁₁(CH₃)₂SiNH₂, C₆H₁₃(CH₃)₂SiNH₂, C₇H₁₅(CH₃)₂SiNH₂, C₈H₁₇(CH₃)₂SiNH₂, C₉H₁₉(CH₃)₂SiNH₂, C₁₀H₂₁(CH₃)₂SiNH₂, C₁₁H₂₃(CH₃)₂SiNH₂, C₁₂H₂₅(CH₃)₂SiNH₂, C₁₃H₂₇(CH₃)₂SiNH₂, C₁₄H₂₉(CH₃)₂SiNH₂, C₁₅H₃₁(CH₃)₂SiNH₂, C₁₆H₃₃(CH₃)₂SiNH₂, C₁₇H₃₅(CH₃)₂SiNH₂, C₁₈H₃₇(CH₃)₂SiNH₂, C₂F₅C₂H₄(CH₃)₂SiNH₂, C₃F₇C₂H₄(CH₃)₂SiNH₂, C₄F₉C₂H₄(CH₃)₂SiNH₂, C₅F₁₁C₂H₄(CH₃)₂SiNH₂, C₆F₁₃C₂H₄(CH₃)₂SiNH₂, C₇F₁₅C₂H₄(CH₃)₂SiNH₂, C₈F₁₇C₂H₄(CH₃)₂SiNH₂, [C₄H₉(CH₃)₂Si]₂NH, [C₅H₁₁(CH₃)₂Si]₂NH, [C₆H₁₃(CH₃)₂Si]₂NH, [C₇H₁₅(CH₃)₂Si]₂NH, [C₅H₁₇(CH₃)₂Si]₂NH, [C₉H₁₉(CH₃)₂Si]₂NH, [C₁₀H₂₁(CH₃)₂Si]₂NH, [C₁₁H₂₃(CH₃)₂Si]₂NH, [C₁₂H₂₅(CH₃)₂Si]₂NH, [C₁₃H₂₇(CH₃)₂Si]₂NH, [C₁₄H₂₉(CH₃)₂Si]₂NH, [C₁₅H₃₁(CH₃)₂Si]₂NH, [C₁₆H₃₃(CH₃)₂Si]₂NH, [C₁₇H₃₅(CH₃)₂Si]₂NH, [C₁₈H₃₇(CH₃)₂Si]₂NH, [C₂F₅C₂H₄(CH₃)₂Si]₂NH, [C₃F₇C₂H₄(CH₃)₂Si]₂NH, [C₄F₉C₂H₄(CH₃)₂Si]₂NH, [C₅F₁₁C₂H₄(CH₃)₂Si]₂NH, [C₆F₁₃C₂H₄(CH₃)₂Si]₂NH, [C₇F₁₅C₂H₄(CH₃)₂Si]₂NH, [C₈F₁₇C₂H₄(CH₃)₂Si]₂NH, [(C₂H₅)₃Si]₂NH, [C₃H₇(C₂H₅)₂Si]₂NH, [C₄H₉(C₂H₅)₂Si]₂NH, [C₅H₁₁(C₂H₅)₂Si]₂NH, [C₆H₁₃(C₂H₅)₂Si]₂NH, [C₇H₁₅(C₂H₅)₂Si]₂NH, [C₈H₁₇(C₂H₅)₂Si]₂NH, [C₉H₁₉(C₂H₅)₂Si]₂NH, [C₁₀H₂₁(C₂H₅)₂Si]₂NH, [C₁₁H₂₃(C₂H₅)₂Si]₂NH, [C₁₂H₂₅(C₂H₅)₂Si]₂NH, [C₁₃H₂₇(C₂H₅)₂Si]₂NH, [C₁₄H₂₉(C₂H₅)₂Si]₂NH, [C₁₅H₃₁(C₂H₅)₂Si]₂NH, [C₁₆H₃₃(C₂H₅)₂Si]₂NH, [C₁₇H₃₅(C₂H₅)₂Si]₂NH, [C₁₈H₃₇(C₂H₅)₂Si]₂NH, [C₄H₉(CH₃)₂Si]₃N, [C₅H₁₁(CH₃)₂Si]₃N, [C₆H₁₃(CH₃)₂Si]₃N, [C₇H₁₅(CH₃)₂Si]₃N, [C₈H₁₇(CH₃)₂Si]₃N, [C₉H₁₉(CH₃)₂Si]₃N, [C₁₀H₂₁(CH₃)₂Si]₃N, [C₁₁H₂₃(CH₃)₂Si]₃N, [C₁₂H₂₅(CH₃)₂Si]₃N, [C₁₃H₂₇(CH₃)₂Si]₃N, [C₁₄H₂₉(CH₃)₂Si]₃N, [C₁₅H₃₁(CH₃)₂Si]₃N, [C₁₆H₃₃(CH₃)₂Si]₃N, [C₁₇H₃₅(CH₃)₂Si]₃N, [C₁₈H₃₇(CH₃)₂Si]₃N, [C₄F₉C₂H₄(CH₃)₂Si]₃N, [C₅F₁₁C₂H₄(CH₃)₂Si]₃N, [C₆F₁₃C₂H₄(CH₃)₂Si]₃N, [C₇F₁₅C₂H₄(CH₃)₂Si]₃N, [C₈F₁₇C₂H₄(CH₃)₂Si]₃N, C₄H₉(CH₃)₂SiN(CH₃)₂, C₅H₁₁(CH₃)₂SiN(CH₃)₂, C₆H₁₃(CH₃)₂SiN(CH₃)₂, C₇H₁₅(CH₃)₂SiN(CH₃)₂, C₈H₁₇(CH₃)₂SiN(CH₃)₂, C₉H₁₉(CH₃)₂SiN(CH₃)₂, C₁₀H₂₁(CH₃)₂SiN(CH₃)₂, C₁₁H₂₃(CH₃)₂SiN(CH₃)₂, C₁₂H₂₅(CH₃)₂SiN(CH₃)₂, C₁₃H₂₇(CH₃)₂SiN(CH₃)₂, C₁₄H₂₉(CH₃)₂SiN(CH₃)₂, C₁₅H₃₁ (CH₃)₂SiN(CH₃)₂, C₁₆H₃₃(CH₃)₂SiN(CH₃)₂, C₁₇H₃₅(CH₃)₂SiN(CH₃)₂, C₁₈H₃₇(CH₃)₂SiN(CH₃)₂, C₅H₁₁(CH₃)HsiN(CH₃)₂, C₆H₁₃(CH₃)HsiN(CH₃)₂, C₇H₁₅(CH₃)HsiN(CH₃)₂, C₈H₁₇(CH₃)HsiN(CH₃)₂, C₉H₁₉(CH₃)HsiN(CH₃)₂, C₁₀H₂₁(CH₃)HsiN(CH₃)₂, C₁₁H₂₃(CH₃)HsiN(CH₃)₂, C₁₂H₂₅(CH₃)HsiN(CH₃)₂, C₃H₂₇(CH₃)HsiN(CH₃)₂, C₁₄H₂₉(CH₃)HsiN(CH₃)₂, C₁₅H₃₁(CH₃)HsiN(CH₃)₂, C₁₆H₃₃(CH₃)HsiN(CH₃)₂, C₁₇H₃₅(CH₃)HsiN(CH₃)₂, C₁₈H₃₇(CH₃)HsiN(CH₃)₂, C₂F₅C₂H₄(CH₃)₂SiN(CH₃)₂, C₃F₇C₂H₄(CH₃)₂SiN(CH₃)₂, C₄F₉C₂H₄(CH₃)₂SiN(CH₃)₂, C₅F₁₁C₂H₄(CH₃)₂SiN(CH₃)₂, C₆F₁₃C₂H₄(CH₃)₂SiN(CH₃)₂, C₇F₁₅C₂H₄(CH₃)₂SiN(CH₃)₂, C₈F₁₇C₂H₄(CH₃)₂SiN(CH₃)₂, (C₂H₅)₃SiN(CH₃)₂, C₃H₇(C₂H₅)₂SiN(CH₃)₂, C₄H₉(C₂H₅)₂SiN(CH₃)₂, C₅H₁₁(C₂H₅)₂SiN(CH₃)₂, C₆H₁₃(C₂H₅)₂SiN(CH₃)₂, C₇H₁₅(C₂H₅)₂SiN(CH₃)₂, C₈H₁₇(C₂H₅)₂SiN(CH₃)₂, C₉H₁₉(C₂H₅)₂SiN(CH₃)₂, C₁₀H₂₁(C₂H₅)₂SiN(CH₃)₂, C₁₁H₂₃(C₂H₅)₂SiN(CH₃)₂, C₁₂H₂₅(C₂H₅)₂SiN(CH₃)₂, C₁₃H₂₇(C₂H₅)₂SiN(CH₃)₂, C₁₄H₂₉(C₂H₅)₂SiN(CH₃)₂, C₁₅H₃₁(C₂H₅)₂SiN(CH₃)₂, C₁₆H₃₃(C₂H₅)₂SiN(CH₃)₂, C₁₇H₃₅(C₂H₅)₂SiN(CH₃)₂, C₁₈H₃₇(C₂H₅)₂SiN(CH₃)₂, (C₄H₉)₃SiN(CH₃)₂, C₅H₁₁(C₄H₉)₂SiN(CH₃)₂, C₆H₁₃(C₄H₉)₂SiN(CH₃)₂, C₇H₁₅(C₄H₉)₂SiN(CH₃)₂, C₈H₁₇(C₄H₉)₂SiN(CH₃)₂, C₉H₁₉(C₄H₉)₂SiN(CH₃)₂, C₁₀H₂₁(C₄H₉)₂SiN(CH₃)₂, C₁₁H₂₃(C₄H₉)₂SiN(CH₃)₂, C₁₂H₂₅(C₄H₉)₂SiN(CH₃)₂, C₁₃H₂₇(C₄H₉)₂SiN(CH₃)₂, C₁₄H₂₉(C₄H₉)₂SiN(CH₃)₂, C₁₅H₃₁(C₄H₉)₂SiN(CH₃)₂, C₁₆H₃₃(C₄H₉)₂SiN(CH₃)₂, C₁₇H₃₅(C₄H₉)₂SiN(CH₃)₂, C₁₈H₃₇(C₄H₉)₂SiN(CH₃)₂, C₅H₁₁(CH₃)Si[N(CH₃)₂]₂, C₆H₁₃(CH₃)Si[N(CH₃)₂]₂, C₇H₁₅(CH₃)Si[N(CH₃)₂]₂, C₈H₁₇(CH₃)Si[N(CH₃)₂]₂, C₉H₁₉(CH₃)Si[N(CH₃)₂]₂, C₁₀H₂₁(CH₃)Si[N(CH₃)₂]₂, C₁₁H₂₃(CH₃)Si[N(CH₃)₂]₂, C₁₂H₂₅(CH₃)Si[N(CH₃)₂]₂, C₁₃H₂₇(CH₃)Si[N(CH₃)₂]₂, C₁₄H₂₉(CH₃)Si[N(CH₃)₂]₂, C₁₅H₃₁(CH₃)Si[N(CH₃)₂]₂, C₁₆H₃₃(CH₃)Si[N(CH₁₃)₂]₂, C₁₇H₃₅(CH₃)Si[N(CH₃)₂]₂, C₁₈H₃₇(CH₃)Si[N(CH₃)₂]₂, C₃F₇C₂H₄(CH₃)Si[N(CH₃)₂]₂, C₄F₉C₂H₄(CH₃)Si[N(CH₃)₂]₂, C₅F₁₁C₂H₄(CH₃)Si[N(CH₃)₂]₂, C₆F₁₃C₂H₁₄(CH₃)Si[N(CH₃)₂]₂, C₇F₁₅C₂H₄(CH₃)Si[N(CH₃)₂]₂, C₈F₁₇C₂H₄(CH₃)Si[N(CH₃)₂]₂, C₆H₁₃Si[N(CH₃)₂]₃, C₇H₁₅Si[N(CH₃)₂]₃, C₈H₁₇Si[N(CH₃)₂]₃, C₉H₁₉Si[N(CH₃)₂]₃, C₁₀H₂₁Si[N(CH₃)₂]₃, C₁₁H₂₃Si[N(CH₃)₂]₃, C₁₂H₂₅Si[N(CH₃)₂]₃, C₁₃H₂₇Si[N(CH₃)₂]₃, C₁₄H₂₉Si[N(CH₃)₂]₃, C₁₅H₁₃₁Si[N(CH₃)₂]₃, C₁₆H₃₃Si[N(CH₃)₂]₃, C₁₇H₃₅Si[N(CH₃)₂]₃, C₁₈H₃₇Si[N(CH₃)₂]₃, C₄F₉C₂H₄Si[N(CH₃)₂]₃, C₅F₁₁C₂H₄Si[N(CH₁₃)₂]₃, C₆F₁₃C₂H₄Si[N(CH₃)₂]₃, C₇F₁₅C₂H₄Si[N(CH₃)₂]₃, C₈F₁₇C₂H₄Si[N(CH₃)₂]₃, C₄H₉(CH₃)₂SiN(C₂H₅)₂, C₅H₁₁(CH₃)₂SiN(C₂H₅)₂, C₆H₁₃(CH₃)₂SiN(C₂H₅)₂, C₇H₁₅(CH₃)₂SiN(C₂H₅)₂, C₈H₁₇(CH₃)₂SiN(C₂H₅)₂, C₉H₁₉(CH₃)₂SiN(C₂H₅)₂, C₁₀H₂₁(CH₃)₂SiN(C₂H₅)₂, C₁₁H₂₃(CH₃)₂SiN(C₂H₅)₂, C₁₂H₂₅(CH₃)₂SiN(C₂H₅)₂, C₁₃H₂₇(CH₃)₂SiN(C₂H₅)₂, C₁₄H₂₉(CH₃)₂SiN(C₂H₅)₂, C₁₅H₃₁(CH₃)₂SiN(C₂H₅)₂, C₁₆H₃₃(CH₃)₂SiN(C₂H₅)₂, C₁₇H₃₅(CH₃)₂SiN(C₂H₅)₂, C₁₈H₃₇(CH₃)₂SiN(C₂H₅)₂, C₄F₉C₂H₄(CH₃)₂SiN(C₂H₅)₂, C₄F₉C₂H₄(CH₃)₂SiN(C₂H₅)₂, C₅F₁₁C₂H₄(CH₃)₂SiN(C₂H₅)₂, C₆F₁₃C₂H₄(CH₃)₂SiN(C₂H₅)₂, C₇F₁₅C₂H₄(CH₃)₂SiN(C₂H₅)₂, C₈F₁₇C₂H₄(CH₃)₂SiN(C₂H₅)₂, (C₂H₅)₃SiN(C₂H₅)₂, C₃H₇(C₂H₅)₂SiN(C₂H₅)₂, C₄H₉(C₂H₅)₂SiN(C₂H₅)₂, C₅F₁₁(C₂H₅)₂SiN(C₂H₅)₂, C₆H₁₃(C₂H₅)₂SiN(C₂H₅)₂, C₇H₁₅(C₂H₅)₂SiN(C₂H₅)₂, C₈H₁₇(C₂H₅)₂SiN(C₂H₅)₂, C₉H₁₉(C₂H₅)₂SiN(C₂H₅)₂, C₁₀H₂₁(C₂H₅)₂SiN(C₂H₅)₂, C₁₁H₂₃(C₂H₅)₂SiN(C₂H₅)₂, C₁₂H₂₅(C₂H₅)₂SiN(C₂H₅)₂, C₁₃H₂₇(C₂H₅)₂SiN(C₂H₅)₂, C₁₄H₂₉(C₂H₅)₂SiN(C₂H₅)₂, C₁₅H₃₁(C₂H₅)₂SiN(C₂H₅)₂, C₁₆H₃₃(C₂H₅)₂SiN(C₂H₅)₂, C₁₇H₃₅(C₂H₅)₂SiN(C₂H₅)₂, C₁₈H₃₇(C₂H₅)₂SiN(C₂H₅)₂, (C₄H₉)₃SiN(C₂H₅)₂, C₅H₁₁(C₄H₉)₂SiN(C₂H₅)₂, C₆H₁₃(C₄H₉)₂SiN(C₂H₅)₂, C₇H₁₅(C₄H₉)₂SiN(C₂H₅)₂, C₈H₁₇(C₄H₉)₂SiN(C₂H₅)₂, C₉H₁₉(C₄H₉)₂SiN(C₂H₅)₂, C₁₀H₂₁(C₄H₉)₂SiN(C₂H₅)₂, C₁₁H₂₃(C₄H₉)₂SiN(C₂H₅)₂, C₁₂H₂₅(C₄H₉)₂SiN(C₂H₅)₂, C₁₃H₂₄C₄H₉)₂SiN(C₂H₅)₂, C₁₄H₂₉(C₄H₉)₂SiN(C₂H₅)₂, C₁₅H₃₁(C₄H₉)₂SiN(C₂H₅)₂, C₁₆H₃₃(C₄H₉)₂SiN(C₂H₅)₂, C₁₇H₃₅(C₄H₉)₂SiN(C₂H₅)₂, C₁₈H₃₇(C₄H₉)₂SiN(C₂H₅)₂, and the like, for example.

If considering the water repellent performance in the case of substituting a hydrogen atom(s) of the hydrocarbon group with a halogen atom(s), the preferable compounds among the above-mentioned silicon compounds are those substituted with fluorine atom as the halogen atom used for substitution (i.e., compounds represented by the general formula [4]). Among silicon compounds substituted with fluorine atom, those that contain five or more fluorine atoms exhibit a great hydrophobicity and therefore more preferable, particularly against a wafer containing a material where hydroxyl group is hardly formed at the surface or a wafer containing a material of which hydroxyl group that exists at the surface has a low reactivity (such as titanium, titanium nitride, tungsten, aluminum, copper, tin, tantalum nitride and ruthenium).

A monovalent functional group of which element to be bonded to silicon element is nitrogen, represented by X in the general formula [1], is required only to consist of elements of carbon, hydrogen, boron, nitrogen, phosphorus, oxygen, sulfur, silicon, germanium, fluorine, chlorine, bromine, iodine and the like. For example, it is possible to cite —NHSi(CH₃)₃ group, —NHSi(CH₃)₂C₄H₉ group, —NHSi(CH₃)₂C₈H₁₇ group, —N(CH₃)₂ group, —N(C₂H₅)₂ group, —N(C₃H₇)₂ group, —N(CH₃)(C₂H₅) group, —NH(C₂H₅) group, NCO group, imidazole group, acetamide group and the like.

A monovalent functional group of which element to be bonded to silicon element is oxygen, represented by X in the general formula [1], is required only to consist of elements of carbon, hydrogen, boron, nitrogen, phosphorus, oxygen, sulfur, silicon, germanium, fluorine, chlorine, bromine, iodine and the like. For example, it is possible to cite —OCH₃ group, —OC₂H₅ group, —OC₃H₇ group, —OCOCH₃ group, —OCOCF₃ group and the like.

Additionally, as a halogen group represented by X in the general formula [1], it is possible to cite —F group, —Cl group, —Br group, —I group and the like. Of these, —Cl group is much preferable.

The group represented by X in the general formula [1] is to react with hydroxyl group on the wafer surface and establishes a bond between silicon element of the silicon compound and the wafer surface, thereby forming a protective film.

Particularly, silicon nitride and polysilicon as mentioned above have a small amount of hydroxyl groups that are resident on the surface of the material, and therefore sometimes few in moiety reactive with the silicon compound. However, if the hydrophobic group of the present invention, represented by R¹ is bulky and if R¹ is a group having a great hydrophobicity, it is possible to obtain an excellently water repellent protective film as a result.

Moreover, hydroxyl groups resident on the surface of the material such as titanium, titanium nitride, tungsten, aluminum, copper, tin, tantalum nitride and ruthenium are low in reactivity with the silicon compound, so that there may be cases where hydroxyl groups cannot completely be reacted. Even in such cases, it is possible to obtain an excellently water repellent protective film as a result if the hydrophobic group represented by R¹ is bulky and if R¹ is a group having a great hydrophobicity.

Additionally, in the case where the material exemplified by titanium, titanium nitride, tungsten, aluminum, copper, tin, tantalum nitride and ruthenium is a metal element or nitride, the amount of hydroxyl groups resident on the surface of the material may be smaller than that in the case of oxide. Even in such cases, it is possible to obtain an excellently water repellent protective film as a result if the hydrophobic group represented by R¹ is bulky and if R¹ is a group having a great hydrophobicity.

Furthermore, “a” in the general formulas [1] and [4] is required only to be an integer of from 1 to 3; however, when “a” is 1 or 2, with the contamination of water and the like due to a long period of storage of the water repellent protective film forming agent or the liquid chemical, the silicon compound may initiate polymerization and a possible storage period may be shortened. In view of this, it is preferable that “a” in the general formulas [1] and [4] is 3.

Moreover, among silicon compounds represented by the general formula [1], those of which R¹ consists of one C₄-C₁₈ hydrocarbon group which is unsubstituted or substituted with halogen atom and two methyl groups (i.e., compounds represented by the general formula [3]) are preferable since the rate of reaction against hydroxyl groups resident on the unevenly patterned surface or on the wafer surface is enhanced thereby. This is because steric hindrance due to hydrophobic group has a great influence upon the reaction rate and because it is preferable that an alkyl chain to be bonded to silicon element has the longest chain and two other shorter chains, in a reaction between hydroxyl group resident on the unevenly patterned surface or on the wafer surface and the silicon compound. Similarly, among silicon compounds in which the total of “a” and “b” in the general formula [4] is 3, silicon compounds in which “b” is 2 and R⁴ is methyl group in either case are preferable since these have good reactivity against hydroxyl group resident on the wafer surface.

In view of the above facts, particularly preferable compounds among the silicon compounds represented by the general formula [1] can be exemplified by C₄H₉(CH₃)₂SiCl, C₅H₁₁(CH₃)₂SiCl, C₆H₁₃(CH₃)₂SiCl, C₇H₁₅(CH₃)₂SiCl, C₈H₁₇(CH₃)₂SiCl, C₉H₁₉(CH₃)₂SiCl, C₁₀H₂₁(CH₃)₂SiCl, C₁₁H₂₃(CH₃)₂SiCl, C₁₂H₂₅(CH₃)₂SiCl, C₁₃H₂₇(CH₃)₂SiCl, C₁₄H₂₉(CH₃)₂SiCl, C₁₅H₃₁(CH₃)₂SiCl, C₁₆H₃₃(CH₃)₂SiCl, C₁₇H₃₅(CH₃)₂SiCl, C₁₈H₃₇(CH₃)₂SiCl, C₂F₅C₂H₄(CH₃)₂SiCl, C₃F₇C₂H₄(CH₃)₂SiCl, C₄F₉C₂H₄(CH₃)₂SiCl, C₅F₁₁C₂H₄(CH₃)₂SiCl, C₆F₁₃C₂H₄(CH₃)₂SiCl, C₇F₁₅C₂H₄(CH₃)₂SiCl, C₈F₁₇C₂H₄(CH₃)₂SiCl, C₄H₉(CH₃)₂SiN(CH₃)₂, C₅H₁₁(CH₃)₂SiN(CH₃)₂, C₆H₁₃(CH₃)₂SiN(CH₃)₂, C₇H₁₅(CH₃)₂SiN(CH₃)₂, C₈H₁₇(CH₃)₂SiN(CH₃)₂, C₉H₁₉(CH₃)₂SiN(CH₃)₂, C₁₀H₂₁(CH₃)₂SiN(CH₃)₂, C₁₁H₂₃(CH₃)₂SiN(CH₃)₂, C₁₂H₂₅(CH₃)₂SiN(CH₃)₂, C₁₃H₂₇(CH₃)₂SiN(CH₃)₂, C₁₄H₂₉(CH₃)₂SiN(CH₃)₂, C₁₅H₃₁(CH₃)₂SiN(CH₃)₂, C₁₆H₃₃(CH₃)₂SiN(CH₃)₂, C₁₇H₃₅(CH₃)₂SiN(CH₃)₂, C₁₈H₃₇(CH₃)₂SiN(CH₃)₂, C₂F₅C₂H₄(CH₃)₂SiN(CH₃)₂, C₃F₇C₂H₄(CH₃)₂SiN(CH₃)₂, C₄F₉C₂H₄(CH₃)₂SiN(CH₃)₂, C₅F₁₁C₂H₄(CH₃)₂SiN(CH₃)₂, C₆F₁₃C₂H₄(CH₃)₂SiN(CH₃)₂, C₇F₁₅C₂H₄(CH₃)₂SiN(CH₃)₂ and C₈F₁₇C₂H₄(CH₃)₂SiN(CH₃)₂.

Furthermore, the liquid chemical for forming a water repellent protective film may be one that contains two or more kinds of silicon compounds represented by the general formula [1] or one that contains a silicon compound represented by the general formula [1] and a silicon compound other than the silicon compound represented by the general formula [1].

Then, the liquid chemical for forming a water repellent protective film, according to the present invention will be discussed. The liquid chemical is required only to contain at least the water repellent protective film forming agent. It is possible to use an organic solvent as a solvent, for the liquid chemical. The organic solvent is required only to be able to dissolve the protective film forming agent; therefore, hydrocarbons, esters, ethers, ketones, halogen element-containing solvents, sulfoxide-based solvents, alcohols, polyalcohol derivatives, nitrogen element-containing solvents and the like are preferably used. When water is used as a solvent for dilution, a group represented by X in the above-mentioned silicon compound causes hydrolysis due to water and then changes to silanol group (SiOH). The thus formed silanol groups initiate condensation reaction therebetween, so that the silicon compounds are bonded to each other to form a dimer. The reactivity of dimer against hydroxyl group resident on the wafer surface is low, so that it is not possible to sufficiently impart water repellency to the wafer surface and a time necessary to provide water repellency is elongated. Hence it is not preferable to use water as a solvent.

Furthermore, since the silicon compound is reactive with a protic solvent, it is particularly preferable to use an aprotic solvent as the organic solvent because water repellency becomes easily exhibited on the wafer surface in a short time. Incidentally, “aprotic solvent” means both aprotic polar solvents and aprotic nonpolar solvents. Such aprotic solvents can be exemplified by hydrocarbons, esters, ethers, ketones, halogen element-containing solvents, sulfoxide-based solvents, polyalcohol derivatives having no hydroxyl group, and nitrogen element-containing solvents having no N—H bond. Examples of hydrocarbons are toluene, benzene, xylene, hexane, [symbol] eptanes, octane and the like. Examples of esters are ethyl acetate, propyl acetate, butyl acetate, ethyl acetoacetate and the like. Examples of ethers are diethyl ether, dipropyl ether, dibutyl ether, tetrahydrofuran, dioxane and the like. Examples of ketones are acetone, acetylacetone, methyl ethyl ketone, methyl propyl ketone, methyl butyl ketone and the like. Examples of the halogen element-containing solvents are: perfluorocarbons such as perfluorooctane, perfluorononane, perfluorocyclopentane, perfluorocyclohexane, hexafluorobenzene and the like; hydrofluorocarbons such as 1,1,1,3,3-pentafluorobutane, octafluorocyclopentane, 2,3-dihydrodecafluoropentane, ZEORORA-H (produced by ZEON CORPORATION) and the like; hydrofluoroethers such as methyl perfluoroisobutyl ether, methyl perfluorobutyl ether, ethyl perfluorobutyl ether, ethyl perfluoroisobutyl ether, ASAHIKLIN AE-3000 (produced by Asahi Glass Co., Ltd.), Novec HFE-7100, Novec HFE-7200, Novec 7300, Novec 7600 (any of these are produced by 3M Limited) and the like; chlorocarbons such as tetrachloromethane and the like; hydrochlorocarbons such as chloroform and the like; chlorofluorocarbons such as dichlorodifluoromethane and the like; hydrochlorofluorocarbons such as 1,1-dichloro-2,2,3,3,3-pentafluoropropane, 1,3-dichloro-1,1,2,2,3-pentafluoropropane, 1-chloro-3,3,3-trifluoropropene, 1,2-dichloro-3,3,3-trifluoroprop ene and the like; perfluoroethers; perfluoropolyethers; and the like. Examples of the sulfoxide-based solvents are dimethyl sulfoxide and the like. Examples of the polyalcohol derivatives having no hydroxyl group are diethylene glycol monoethyl ether acetate, ethylene glycol monomethyl ether acetate, ethylene glycol monobutyl ether acetate, propylene glycol monomethyl ether acetate, propylene glycol monoethyl ether acetate, diethylene glycol dimethyl ether, diethylene glycol ethyl methyl ether, diethylene glycol diethyl ether, diethylene glycol monomethyl ether acetate, diethylene glycol diacetate, triethylene glycol dimethyl ether, triethylene glycol diethyl ether, dipropylene glycol dimethyl ether, ethylene glycol diacetate, ethylene glycol diethyl ether, ethylene glycol dimethyl ether and the like. Examples of the nitrogen element-containing solvents having no N—H bond are N,N-dimethylformamide, N,N-dimethylacetamide, N-methyl-2-pyrrolidone, triethylamine, pyridine and the like.

Additionally, it is preferable to use a nonflammable solvent as the above-mentioned organic solvent since the liquid chemical for forming a water repellent protective film becomes nonflammable or increases in flash point. Most of the halogen element-containing solvents are nonflammable, so that such a halogen element-containing nonflammable solvent can be preferably used as a nonflammable organic solvent.

In addition, it is preferable to use a polar solvent as the organic solvent because a reaction between a silicon compound serving as the protective film forming agent and hydroxyl group resident on the wafer surface proceeds smoothly.

Additionally, the organic solvent may allow the content of water, if it is in a very small amount. However, if water is massively contained in the solvent, a silicon compound may cause hydrolysis by the water content so as to be reduced in reactivity. Hence the water content in the solvent is preferably small, and more specifically, it is preferable that the water content (at the time of being contained in the solvent) is less than 1 mole time the silicon compound in mole ratio, particularly preferably less than 0.5 mole time the silicon compound in mole ratio.

In the liquid chemical for forming a protective film, the water repellent protective film forming agent is preferably contained in an amount of 0.1 to 50 mass % relative to 100 mass % of the total amount of the liquid chemical, more preferably contained in an amount of 0.3 to 20 mass % relative to 100 mass % of the total amount of the liquid chemical. The water repellent protective film forming agent of smaller than 0.1 mass % tends to make the water repellency-imparting effect insufficient while that of larger than 50 mass % brings about a fear that the components derived from the water repellent protective film forming agent remains as impurities on the wafer surface after cleaning, which is therefore not preferable. Furthermore, such cases increase the amount of the water repellent protective film forming agent to be used, and therefore not preferable from the viewpoint of cost.

Additionally, in order to accelerate the reaction between the silicon compound and hydroxyl group resident on the wafer surface, the addition of a catalyst to the liquid chemical is allowed. Preferably usable examples of the catalyst are acids containing no water such as trifluoroacetic acid, trifluoroacetic anhydride, pentafluoropropionic acid, pentafluoropropionic anhydride, trifluoromethanesulfonic acid, trifluoromethanesulfonic anhydride, sulfuric acid, hydrogen chloride and the like; bases such as ammonia, alkylamine, N,N,N′,N′-tetrathethylethylenediamine, triethylenediamine, dimethylaniline, pyridine, piperazine, N-alkylmorpholine and the like; salts such as ammonium sulfide, potassium acetate, methylhydroxyamine hydrocholide and the like; and a metallic complex or a metallic salt of tin, aluminum, titanium or the like. Particularly, if taking a catalytic effect into account, the preferable examples are the acids such as trifluoroacetic acid, trifluoroacetic anhydride, trifluoromethanesulfonic acid, trifluoromethanesulfonic anhydride, sulfuric acid, hydrogen chloride and the like, and additionally, the acids preferably do not contain water. Moreover, the catalyst may be one that forms a part of the water repellent protective film by the reaction.

Particularly when the carbon number of the hydrophobic group R¹ in the general formula [1] is large, steric hindrance is caused thereby sometimes reducing the reactivity of the silicon compound against hydroxyl group resident on the wafer surface. In such cases, an acid containing no water may be added as the catalyst, with which the reaction between the silicon compound and hydroxyl group resident on the wafer surface is accelerated thereby sometimes compensating the reaction rate that is reduced by steric hindrance caused by hydrophobic group as mentioned above.

The amount of addition of the catalyst is preferably 0.01 to 100 mass % relative to 100 mass % of the total amount of the silicon compound. A small amount of addition lessens the catalytic effect and therefore not preferable. Additionally, an excessive amount of addition does not enhance the catalytic effect, rather sometimes lessens the catalytic effect if it becomes larger than that of the silicon compound. In addition, there arises a fear that the catalyst remains as an impurity on the wafer surface. Hence the amount of addition of the catalyst is preferably 0.01 to 100 mass %, more preferably 0.1 to 50 mass %, much more preferably 0.2 to 20 mass % relative to 100 mass % of the total amount of the silicon compound.

The liquid chemical of the present invention may be of a one-pack type in which the silicon compound and the catalyst are mixed from the beginning, or of a two-pack type in which a liquid containing the silicon compound and a liquid containing the catalyst are mixed before use.

Then, a method for cleaning a wafer, according to the present invention will be discussed.

In general, as a wafer to be cleaned by using the liquid chemical of the present invention, there is often used one that has been subjected to a pretreatment step where a surface of a wafer is made into a surface having an uneven pattern.

A method for the pretreatment step is not particularly limited as far as it is possible to form a wafer to have a patterned surface. In an usual method therefor, a resist is applied to a surface of a wafer and then the resist is exposed to light through a resist mask, followed by conducting an etching removal on the exposed resist or an unexposed resist thereby producing a resist having a desired uneven pattern. Additionally, a resist having an uneven pattern can be obtained also by pushing a mold having a pattern onto the resist. Then, etching is conducted on the wafer. At this time, the wafer surface corresponding to recessed portions of the resist pattern are etched selectively. Finally, the resist is stripped off thereby obtaining a wafer having an uneven pattern.

Incidentally, the wafer used for cleaning means a wafer that contains a material including silicon element or a wafer that contains at least one kind of material selected from the group consisting of titanium, titanium nitride, tungsten, aluminum, copper, tin, tantalum nitride and ruthenium. The wafer that contains a material including silicon element involves: a silicon wafer; a silicon wafer on which a silicon oxide film is formed by thermal oxidation method, CVD method, sputtering method or the like; a silicon wafer on which a silicon nitride film or a polysilicon film is formed by CVD method, sputtering method or the like; and a silicon wafer in which the silicon nitride film or the polysilicon film or the surface thereof is naturally oxidized. Additionally, as the wafer, it is also possible to use: a wafer formed of a plurality of components including silicon and/or silicon oxide; a silicon carbide wafer; and wafers on which various kinds of films containing silicon element are formed. Furthermore, wafers that do not contain silicon element (such as a sapphire wafer, various compound semiconductor wafers, a plastic wafer and the like) and formed to have various kinds of films containing silicon element thereon are also acceptable. Incidentally, the liquid chemical is able to form a protective film to impart water repellency to: the surface of the wafer that contains silicon element; the surface of the film that is formed on the wafer and contains silicon element; or the surface of a portion of the uneven pattern at which the wafer or the film contains silicon element.

In a wafer that forms a silicon oxide film or has a large amount of silicon oxide portion on its surface, in general, there exists an abundance of hydroxyl groups (serving as an active site) on the surface so that the water repellent performance is easily imparted thereto. On the contrary, it has been difficult in conventional techniques to impart the water repellent performance to wafers having few hydroxyl groups on its surface; such as a wafer that forms a silicon nitride film or has a large amount of silicon nitride portion on its surface, a wafer that forms a polysilicon film or a large amount of polysilicon portion on its surface, and a silicon wafer itself. However, the use of the liquid chemical of the present invention allows imparting an adequate water repellency to the wafer surface and additionally provides the effect of preventing the pattern collapse at the time of cleaning, even against such wafers. Accordingly, a wafer that widely has a silicon oxide film or a silicon oxide portion on its surface, as a matter of course, a wafer that forms a silicon nitride film or has a large amount of silicon nitride portion on its surface, a wafer that forms a large amount of polysilicon film or polysilicon portion, and a silicon wafer are suitable and preferable materials for application of the liquid chemical of the present invention. Of these, a wafer that forms a silicon nitride film or has a large amount of silicon nitride portion is particularly preferable.

Moreover, as a wafer that contains at least one kind of material selected from the group consisting of titanium, titanium nitride, tungsten, aluminum, copper, tin, tantalum nitride and ruthenium, it is possible to cite: wafers obtained by coating a surface of a silicon wafer, a wafer formed of a plurality of components including silicon and/or silica (SiO₂), a silicon carbide wafer, a sapphire wafer, various compound semiconductor wafers, a plastic wafer or the like with a layer formed of a metal-based material such as titanium, titanium nitride, tungsten, aluminum, copper, tin, tantalum nitride and ruthenium; wafers formed having a multilayer film thereon and wherein at least one layer is a layer of the metal-based material; and the like. The above-mentioned uneven pattern forming step is conducted on the layer including a layer of the metal-based material. Additionally, wafers in which at least a part of the uneven pattern becomes the metal-based material at the time of forming the uneven pattern are also included. Furthermore, wafers obtained by forming an uneven pattern on a wafer and then forming a layer of the metal-based material on the surface of the uneven pattern are also included.

Also in a wafer formed of a plurality of components including the metal-based material, it is possible to form the protective film on the surface of the metal-based material. As the wafer formed of a plurality of components, it is possible to include: wafers on which surface the metal-based material is formed; and wafers in which at least a part of the uneven pattern becomes the metal-based material at the time of forming the uneven pattern. Incidentally; where the protective film is formed by using a liquid chemical relating to the second embodiment of the present invention is a surface of at least a portion of the uneven pattern, the portion being formed of the metal-based material.

A method for cleaning a wafer that has an uneven pattern at its surface and contains silicon element at least at surfaces of recessed portions of the uneven pattern, according to the present invention involves:

a cleaning step using a water-based cleaning liquid, where the surface of the wafer is cleaned with a water-based cleaning liquid;

a water repellent protective film forming step where a liquid chemical for forming a water repellent protective film is retained at least in the recessed portions at the surface of the wafer thereby forming a water repellent protective film on the surfaces of the recessed portions;

a liquid removal step where a liquid on the surface of the wafer is removed; and

a water repellent protective film removal step where the water repellent protective film is removed from the surfaces of the recessed portions.

As examples of the water-based cleaning liquid, it is possible to cite: water; and liquids that contain water as the primary component (for example, 50 mass % or more water content) and obtained by mixing at least one kind of an organic solvent, acid, alkali, a surfactant, hydrogen peroxide and ozone with water.

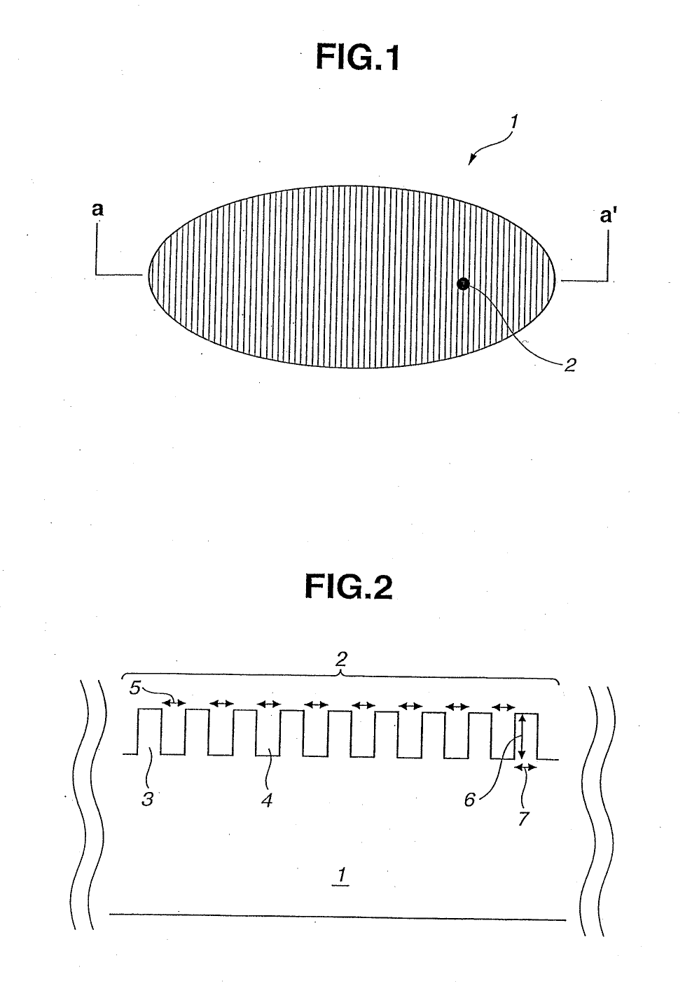

After removal of the resist, particles and the like resident on the surface of the wafer are removed by the cleaning conducted by using a water-based cleaning liquid, and then the water-based cleaning liquid is removed by drying or the like. If the recessed portions have a small width and projected portions have a large aspect ratio at this time, the pattern collapse is to easily occur. The uneven pattern is defined as shown in FIG. 1 and FIG. 2. FIG. 1 is a schematic plan view of a wafer 1 whose surface is made into a surface having an uneven pattern 2. FIG. 2 is a view showing a part of a-a′ cross section of FIG. 1. A width 5 of recessed portions is defined by an interval between adjacent projected portions 3 and a projected portion 3, as shown in FIG. 2. The aspect ratio of projected portions is expressed by dividing a height 6 of the projected portions by a width 7 of the projected portions. The pattern collapse in the cleaning step is to easily occur when the recessed portions have a width of not more than 70 nm, particularly not more than 45 nm and when the aspect ratio is not less than 4, particularly not less than 6.

Moreover, a portion to be brought into contact with a water-based cleaning liquid by retention and formed of at least one kind of material selected from the group consisting of silicon nitride, polysilicon, titanium, titanium nitride, tungsten, aluminum, copper, tin, tantalum nitride and ruthenium is oxidized at a part of the surface by the contact with the water-based cleaning liquid thereby forming hydroxyl group. Though this oxidation may be a slight one (depending on material), the water repellent protective film forming agent provided by the present invention has a bulky hydrophobic group so that it is possible to form an excellent water repellent protective film even if the water repellent protective film forming agent to be reacted with a part of hydroxyl groups formed by oxidation is in a small amount.

This oxidation of the wafer surface proceeds even if the water-based cleaning liquid is a pure water of room temperature. However, when the acidity of the water-based cleaning liquid is high or when the temperature of the water-based cleaning liquid is high, oxidation tends to proceed rapidly; therefore it is possible to add acid to the water-based cleaning liquid and it is possible to increase the temperature of the water-based cleaning liquid for the purpose of accelerating oxidation. Furthermore, it is also possible to add hydrogen peroxide, ozone or the like, for the purpose of accelerating oxidation.

In the method for cleaning a wafer according to the present invention, in order to efficiently perform cleaning without causing the pattern collapse, it is preferable to maintain a condition where a liquid is invariably retained at least in the recessed portions of the wafer from the cleaning step using a water-based cleaning liquid through the water repellent protective film forming step. Also in the case of substituting the liquid chemical for forming a water repellent protective film retained in the recessed portions of the wafer with another liquid after the water repellent protective film forming step, it is preferable to carry out the step under a condition where a liquid is invariably retained at least in the recessed portions of the wafer, similarly to the above. In the present invention, it is essential only that the water-based cleaning liquid, the liquid chemical or another liquid is retained at least in the recessed portions of the uneven pattern of the wafer; therefore, a wafer cleaning style is not particularly limited. Examples of the wafer cleaning style are: a sheet cleaning style represented by spin cleaning, where a wafer is generally horizontally disposed and rotated and cleaned one by one with supplying a liquid to the vicinity of the center of the rotation; and a batch style where a plurality of wafers are immersed in a cleaning bath to be cleaned. Incidentally, the form of the water-based cleaning liquid cleaning liquid, the liquid chemical or the other liquid at the time of supplying the water-based cleaning liquid, the liquid chemical or the other liquid at least to recessed portions of the uneven pattern of the wafer is not particularly limited as far as it becomes the form of liquid at time of being retained in the recessed portions, and may be the form of liquid, vapor or the like, for instance.

Then, the water repellent protective film forming step will be discussed. A shift from the cleaning step using a water-based cleaning liquid to the water repellent protective film forming step is achieved by substituting the water-based cleaning liquid having been retained at least in the recessed portions of the uneven pattern of the wafer during the cleaning step using a water-based cleaning liquid with the liquid chemical for forming a water repellent protective film. The substitution of the water-based cleaning liquid with the liquid chemical for forming a water repellent protective film may be a direct substitution, or may be a substitution where the water-based cleaning liquid is substituted with a different cleaning liquid (A) (hereinafter, sometimes referred to merely as “a cleaning liquid (A)”) one or more time and thereafter substituted with the liquid chemical for forming a water repellent protective film. Preferable examples of the cleaning liquid (A) are water, an organic solvent, a mixture of water and an organic solvent, a mixture of these and at least one kind of acid, alkali and a surfactant, and the like. Additionally, examples of the organic solvent, which is one of the preferable examples of the cleaning liquid (A), include hydrocarbons, esters, ethers, ketones, halogen element-containing solvents, sulfoxide-based solvents, alcohols, polyalcohol derivatives, nitrogen element-containing solvents and the like.

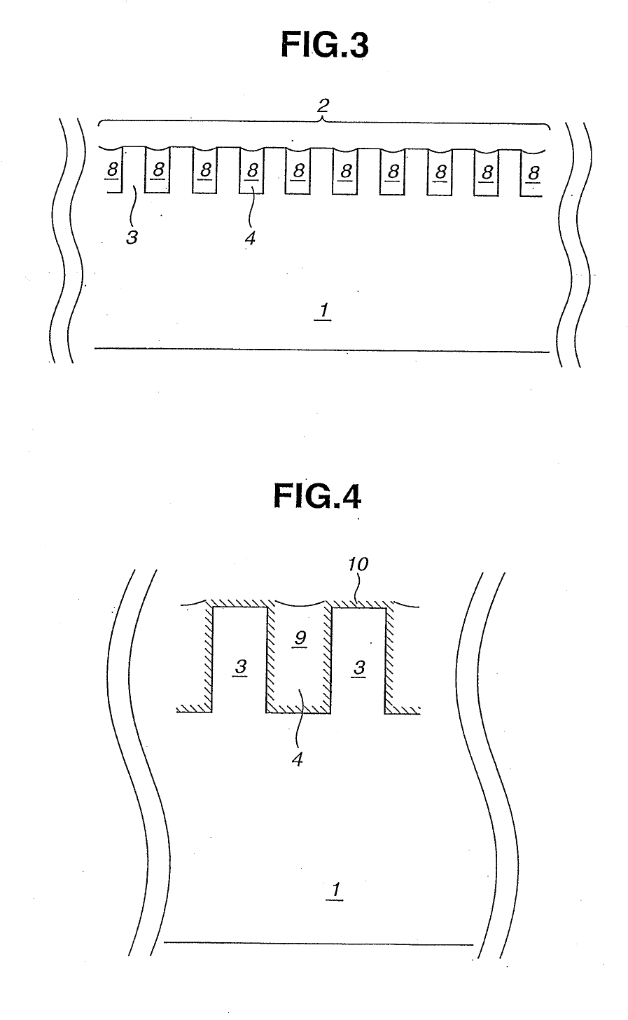

Formation of the water repellent protective film, achieved in the water repellent protective film forming step is carried out by retaining the liquid chemical for forming a water repellent protective film at least in the recessed portions of the uneven pattern of the wafer. FIG. 3 is a schematic view showing a condition where a liquid chemical 8 for forming a water repellent protective film is retained in recessed portions 4. The wafer of the schematic view of FIG. 3 shows a part of an a-a′ cross section in FIG. 1. At the time of the water repellent protective film forming step, the liquid chemical for forming a water repellent protective film is provided onto the wafer 1 in which the uneven pattern 2 is formed. At this time, the liquid chemical for forming a water repellent protective film is brought into a condition retained at least in the recessed portions 4 as shown in FIG. 3, thereby imparting water repellency to the surfaces of the recessed portions 4. Incidentally, the protective film of the present invention is not necessarily formed continuously, and not necessarily formed evenly; however, it is preferable to form it continuously and evenly in order to provide water repellency more excellently.

When the temperature of the liquid chemical is increased in the protective film forming step, the protective film can be formed easily in a shorter time. However, there is a fear that the liquid chemical for forming a water repellent protective film loses stability due to its boiling, vaporization or the like, so that the liquid chemical is preferably retained at 10 to 160° C., particularly preferably at 15 to 120° C.

A schematic view of a case where a liquid 9 is retained in the recessed portions 4 provided with water repellency by a water repellent protective film forming agent is shown in FIG. 4. The wafer as shown in the schematic view of FIG. 4 shows a part of an a-a′ cross section of FIG. 1. On the surfaces of the recessed portions 4, a water repellent protective film 10 is formed by a water repellent protective film forming agent. The liquid 9 retained in the recessed portions 4 at this time may be the liquid chemical, or a liquid (a cleaning liquid (B)) after substituting the liquid chemical with a liquid which is different from the liquid chemical (hereinafter, sometimes referred to merely as “a cleaning liquid (B)”), or a liquid on the way to substitution (i.e., a mixed liquid of the liquid chemical and the cleaning liquid (B)). The water repellent protective film 10 is retained on the surface of the wafer even when the liquid 9 is removed from the recessed portions 4.

Preferable examples of the cleaning liquid (B) are water, an organic solvent, a mixture of water and an organic solvent, a mixture of these and at least one kind of acid, alkali and a surfactant, and the like. Additionally, examples of the organic solvent, which is one of the preferable examples of the cleaning liquid (B), include hydrocarbons, esters, ethers, ketones, halogen element-containing solvents, sulfoxide-based solvents, alcohols, polyalcohols, polyalcohol derivatives, nitrogen element-containing solvents and the like.

When a liquid is retained in the recessed portions of the wafer having an uneven pattern, a capillary force is to act on the recessed portions. The magnitude of the capillary force is an absolute value “P” obtained by the equation as represented below.

P=2×γ×cos θ/S

(In the equation, γ represents the surface tension of a liquid retained in the recessed portions, θ represents the contact angle of the liquid retained in the recessed portions to the surfaces of the recessed portions, and S represents the width of the recessed portions.)

If a water repellent protective film exists on the surfaces of the recessed portions as shown by the recessed portions 4 of FIG. 4, θ is to increase while decreasing the absolute value “P”. From the viewpoint of suppressing the pattern collapse, a smaller absolute value “P” is more preferable, and it is ideal to put the capillary force close to 0.0 MN/m² as much as possible by adjusting the contact angle of the liquid to be removed to around 90°.

When the protective film 10 is formed on the surfaces of the recessed portions as shown in FIG. 4, a contact angle of from 65 to 115° is preferable on the assumption that water is retained on the surfaces, because the pattern collapse becomes difficult to occur. The closer to 90° the contact angle is, the smaller the capillary force acting on the recessed portions becomes, so that the pattern collapse is made further difficult to occur. It is therefore particularly preferable that the contact angle is from 70 to 110°. For example, in the case of a wafer formed having a line-and-space pattern the line width (the width of the recessed portions) of which is 45 nm, it is preferable that the capillary force is not higher than 2.1 MN/m². The capillary force of not higher than 2.1 MN/m² is preferable since the pattern collapse is difficult to occur. Moreover, a lower capillary force makes the pattern collapse further difficult to occur, so that it is particularly preferable that the capillary force is not higher than 1.1 MN/m². Furthermore, it is ideal to put the capillary force close to 0.0 MN/m² as much as possible by adjusting the contact angle of the liquid to be removed to around 90°.

Then, the liquid removal step will be discussed. Incidentally; the liquid retained in the recessed portions is the liquid chemical, the cleaning liquid (B) or the mixed liquid of the liquid chemical and the cleaning liquid (B). As a method for removing the liquid, it is preferable to conduct a conventionally known drying method such as natural drying, air drying, N2 gas drying, spin drying, iPA (2-propanol) steam drying, Marangoni drying, heating drying, warm air drying, vacuum drying and the like. In order to remove the liquid with efficiency, the retained liquid may be drained and then the remaining liquid may be subjected to drying.

Finally, there will be discussed the water repellent protective film removal step. At the time of removing the water repellent protective film, it is effective to cleave C—C bond and C—F bond in the protective film. A method therefor is not particularly limited so long as it is possible to cleave the above-mentioned bonds, and exemplified by: irradiating the wafer surface with light; heating the wafer; exposing the wafer to ozone; irradiating the wafer surface with plasma; subjecting the wafer surface to corona discharge; and the like.

In the case of removing the protective film by light irradiation, it is preferable to conduct an irradiation with ultraviolet rays having a wavelength of shorter than 340 nm and 240 nm (corresponding to bond energies of C—C bond and C—F bond, i.e., 83 kcal/mol and 116 kcal/mol, respectively). As the light source therefor, there is used a metal halide lamp, a low-pressure mercury lamp, a high-pressure mercury lamp, an excimer lamp, a carbon arc or the like.

Additionally, in the case of removing the protective film by light irradiation, it is particularly preferable to generate ozone in parallel with decomposing the components of the protective film by ultraviolet rays and then to induce oxidation-volatilization of the components of the protective film by the ozone, since a treatment time is saved thereby. As the light source therefor, the low-pressure mercury lamp, the excimer lamp or the like may be used. Moreover, the wafer may be heated while being subjected to light irradiation.

In the case of heating the wafer, it is preferable to conduct heating of the wafer at 400 to 700° C., preferably at 500 to 700° C. The heating time is preferably kept for 1 to 60 minutes, and more preferably for 10 to 30 minutes. Additionally, this step may be conducted in combination with ozone exposure, plasma irradiation, corona discharge or the like. Furthermore, the light irradiation may be conducted while heating the wafer.

A method for removing the protective film by heating is exemplified by a method of bringing a wafer into contact with a heat source, a method of setting a wafer aside in a heated atmosphere such as a heat treat furnace and the like, and the like. Incidentally, the method of setting a wafer aside in a heated atmosphere can easily and evenly impart energy for removing the protective film to the wafer surface even in the case of treating the plural sheets of wafers, and therefore serves as an industrially advantageous method with simple operations, a short treatment time and a high treatment capacity.

In the case of exposing the wafer to ozone, it is possible to expose the wafer surface to ozone generated by ultraviolet irradiation using the low-pressure mercury lamp, low-temperature discharge using high voltages or the like. The wafer may be irradiated with light or heated while being exposed to ozone.

By combining the above-mentioned light irradiation, heating, ozone exposure, plasma irradiation and corona discharge, it becomes possible to efficiently remove the protective film formed on the wafer surface.

### EXAMPLES

A technique of making a surface of a wafer into a surface having an uneven pattern and a technique of substituting a cleaning liquid retained at least in recessed portions of the uneven pattern with another cleaning liquid have been variously studied as discussed in other literatures and the like, and have already been established. Accordingly, in Examples of the present invention, there were mainly performed evaluations concerning a liquid chemical for forming a protective film.

The capillary force which acts on the recessed portions of the uneven pattern is represented by the following equation.

P=2×γ×cos θ/S

(In the equation, γ represents the surface tension of a liquid retained in the recessed portions, θ represents the contact angle of the liquid retained in the recessed portions to the surfaces of the recessed portions, and S represents the width of the recessed portions.)

As apparent from this equation, the capillary force “P” that can cause the pattern collapse greatly depends on the contact angle of a cleaning liquid to the surface of the wafer, i.e. the contact angle of a liquid drop and on the surface tension of the cleaning liquid. In the case of a cleaning liquid retained in recessed portions 4 of an uneven pattern 2, the contact angle of a liquid drop and the capillary force acting on the recessed portions (the capillary force can be regarded as being equal to the pattern collapse) are in correlation with each other, so that it is possible to derive the capillary force from the equation and the evaluations of the contact angle of the liquid drop to a water repellent protective film 10. In Examples, water, which is representative of a water-based cleaning liquid, was used as the cleaning liquid.

An evaluation of the contact angle of waterdrop is conducted by dropping several microliters of waterdrop on a surface of a sample (a substrate) and then by measuring an angle formed between the waterdrop and the substrate surface, as discussed in JIS R 3257 (Testing method of wettability of glass substrate surface). However, in the case of the wafer having a pattern, the contact angle is enormously large. This is because Wenzel's effect or Cassie's effect is caused so that an apparent contact angle of the waterdrop is increased under the influence of a surface shape (roughness) of the substrate upon the contact angle. Accordingly, in the case of a wafer having an uneven pattern at its surface, it is not possible to exactly evaluate the contact angle of the protective film 10 itself, the protective film 10 being formed on the unevenly patterned surface.

In view of the above, in Examples of the present invention, the liquid chemical is supplied onto a wafer having a smooth surface to form a protective film on the surface of the wafer. The protective film is regarded as a protective film 10 formed on the surface of a wafer 1 having at its surface an uneven pattern 2. Thus evaluations were variously performed.

### Example 1

In Example 1, examinations as to treatments on silicon oxide and silicon nitride were performed. As wafers in which silicon oxide and silicon nitride have a smooth surface, there were respectively used: “a silicon wafer having a SiO₂ film” where a silicon wafer having a smooth surface has a silicon oxide layer thereon (this wafer is indicated in Table 1 by SiO₂); and “a silicon wafer having a SiN film” where a silicon wafer having a smooth surface has a silicon nitride layer thereon (this wafer is indicated in Table 1 by SiN).

Details will be discussed below. Hereinafter, there will be discussed: a method for evaluating a wafer to which a liquid chemical for forming a protective film was supplied; preparation of the liquid chemical for forming a protective film; and results of evaluation made after supplying the liquid chemical for forming a protective film to the wafer.

[Method for Evaluating Wafer to which Liquid Chemical for Forming Protective Film was Supplied]

As a method for evaluating a wafer to which a liquid chemical for forming a protective film was supplied, the following evaluations (1) to (3) were performed.

### (1) Evaluation of Contact Angle of Protective Film Formed on Wafer Surface

About 2 μl of pure water was dropped on a surface of a wafer on which a protective film was formed, followed by measuring an angle formed between the waterdrop and the wafer surface by using a contact angle meter (produced by Kyowa Interface Science Co., Ltd.: CA-X Model), thereby obtaining the contact angle. A sample where the contact angle to the protective film was within a range of from 65 to 115° was classified as being acceptable.

### (2) Removability of Protective Film

The sample was irradiated with UV rays from a low-pressure mercury lamp for 1 minute under the following conditions, upon which the removability of the protective film in a water repellent protective film removal step was evaluated. A sample on which waterdrop had a contact angle of not larger than 10° after the irradiation was classified as being acceptable.
Lamp: PL2003N-10 produced by SEN LIGHTS CORPORATION
Illuminance: 15 mW/cm² (the distance from the light source to the sample was 10 mm)

### (3) Evaluation of Surface Smoothness of Wafer after Removing Protective Film

The surface was observed by atomic force microscope (produced by Seiko Instruments Inc.: SPI3700, 2.5 micrometer square scan) thereby obtaining the centerline average surface roughness Ra (nm). Incidentally, “Ra” is a three-dimensionally enlarged one obtained by applying the centerline average roughness defined by JIS B 0601 to a measured surface and is calculated as “an average value of absolute values of difference from standard surface to designated surface” from the following equation. If the Ra value of the wafer surface after the protective film was removed was not larger than 1 nm, the wafer surface was regarded as not having been eroded by the cleaning and regarded as not having left residues of the protective film thereon, and therefore classified as an acceptable one.

$$Ra = \frac{1}{{S}_{0}} {\int }_{{Y}_{T}}^{{Y}_{B}} {\int }_{{X}_{L}}^{{X}_{R}} \vert F ( X , Y ) - {Z}_{0} \vert d X d Y$$

where X_{L} and X_{R}, and Y_{B} and Y_{T} represent a measuring range in the X coordinate and the Y coordinate, respectively. S₀ represents an area obtained on the assumption that the measured surface is ideally flat, and is a value obtained by (X_{R}−X_{L})×(Y_{B}−Y_{T}). Additionally, F(X,Y) represents the height at a measured point (X,Y). Z₀ represents the average height within the measured surface.

### Example 1-1

### (1) Preparation of Liquid Chemical for Forming Protective Film

A mixture of: 1 g of nonafluorohexyldimethylchlorosilane [C₄F₉(CH₂)₂(CH₃)₂SiCl] that serves as a protective film forming agent; 96 g of hydrofluoroether (HFE-7100 produced by 3M Limited); and 3 g of propylene glycol monomethyl ether acetate (PGMEA) was prepared (HFE-7100 and PGMEA serve as an organic solvent and represented by HFE-7100/PGMEA in Table 1). Then, the mixture was stirred for about 5 minutes, thereby obtaining a liquid chemical for forming a protective film in which the concentration of a protective film forming agent (hereinafter referred to as “the protective film forming agent concentration”) was 1 mass % relative to the total amount of the liquid chemical for forming a protective film.

### (2) Cleaning of Wafer

A silicon wafer having a smooth silicon oxide film (a silicon wafer on which surface a thermal oxide film of 1 μm thickness was formed) was immersed in 1 mass % hydrogen fluoride aqueous solution for 2 minutes, and then immersed in pure water for 1 minute, and then immersed in 2-propanol for 1 minute. Additionally, a silicon wafer having a silicon nitride film, produced by LP-CVD (a silicon wafer having a silicon nitride film of 50 nm thickness on its surface) was immersed in 1 mass % hydrogen fluoride aqueous solution for 2 minutes, and then immersed in pure water for 1 minute, and then immersed in a cleaning liquid (obtained in such a manner as to mix a 28 mass % aqueous ammonia, a 30 mass % aqueous hydrogen peroxide and water in the volume ratio of 1:1:5 and heat it to a temperature of 70° C. by a hot plate) for 1 minute, and then immersed in pure water for 1 minute, and then immersed in 2-propanol for 1 minute.

### (3) Surface Treatment on Wafer Surface, Using Liquid Chemical for Forming Protective Film

The silicon wafer having a silicon oxide film and the silicon wafer having a silicon nitride film were each immersed in the liquid chemical for forming a protective film (the liquid chemical having been prepared as discussed in the above “(1) Preparation of Liquid Chemical for forming Protective Film” section) at 20° C. for 1 minute. Subsequently, the wafers were immersed in 2-propanol for 1 minute and then immersed in pure water for 1 minute. Finally, the wafers were taken out of the pure water, followed by spraying air thereon to remove the pure water from the surface.

As a result of evaluating the thus obtained each wafer in a manner discussed in the above [Method for Evaluating Wafer to which Liquid Chemical for Forming Protective Film was Supplied] section, a silicon wafer having a silicon oxide film and having an initial contact angle of smaller than 10° before the surface treatment had a contact angle of 101° after the surface treatment as shown in Table 1, with which it was confirmed that a water repellency imparting effect was excellently exhibited. Moreover, the contact angle of the wafer after UV irradiation was smaller than 10°, with which it was confirmed that removal of the protective film was achieved. Furthermore, the Ra value of the wafer after UV irradiation was smaller than 0.5 nm, so that it was confirmed that the wafer was not eroded at the time of cleaning and that residues of the water repellent protective film did not remain after UV irradiation.

Additionally, a silicon wafer having a silicon nitride film and having an initial contact angle of smaller than 10° before the surface treatment had a contact angle of 94° after the surface treatment, with which it was confirmed that a water repellency imparting effect was excellently exhibited. Moreover, the contact angle of the wafer after UV irradiation was smaller than 10°, with which it was confirmed that removal of the protective film was achieved. Furthermore, the Ra value of the wafer after UV irradiation was smaller than 0.5 nm, so that it was confirmed that the wafer was not eroded at the time of cleaning and that residues of the water repellent protective film did not remain after UV irradiation.

Thus, it was confirmed that the water repellency imparting effect can be excellently obtained and the cleaning can be efficiently performed if nonafluorohexyldimethylchlorosilane [C₄F₉(CH₂)₂(CH₃)₂SiCl] is used as the protective film forming agent, in both the silicon wafer having a silicon oxide film of which surface is rich in hydroxyl groups and the silicon wafer having a silicon nitride film of which surface is poor in hydroxyl groups.

TABLE 1

| | Liquid Chemical for Forming Protective Film | | | | | | | Evaluation Results (SiO₂) | | | | Evaluation Results (SiN) | | | |
|---|---|---|---|---|---|---|---|---|---|---|---|---|---|---|---|
| | | Protective | | | | | | | | Remova- | | | | Remova- | |
| | | Film | | | | | | | Contact | bility | | | Contact | bility | |
| | | Forming | | | | | Treat- | | Angle | of | | | Angle | of | |
| | | Agent | | | | Treat- | ment | Initial | After | Protective | | Initial | after | Protective | Surface |
| | | Concen- | | Catalyst | | ment | Temper- | Contact | Surface | Film | Surface | Contact | Surface | Film | Smooth- |
| | Protective Film | tration | | Concentration | Organic | Time | ature | Angle | Treatment | (Contact | Smoothness | Angle | Treatment | (Contact | ness |
| | Forming Agent | [mass %] | Catalyst | [mass %] | Solvent | [min] | [° C.] | [°] | [°] | Angle [°]) | (Ra [nm]) | [°] | [°] | Angle [°]) | (Ra [nm]) |
| Example 1-1 | C₄F₉(CH₂)₂(CH₃)₂SiCl | 1 | — | — | HFE-7100/PGMEA | 1 | 20 | <10 | 101 | <10 | <0.5 | <10 | 94 | <10 | <0.5 |
| Example 1-2 | C₄F₉(CH₂)₂(CH₃)₂SiCl | 1 | — | — | CTFP/PGMEA | 1 | 20 | <10 | 103 | <10 | <0.5 | <10 | 97 | <10 | <0.5 |
| Example 1-3 | C₄F₉(CH₂)₂(CH₃)₂SiCl | 1 | — | — | DCTFP/PGMEA | 1 | 20 | <10 | 102 | <10 | <0.5 | <10 | 95 | <10 | <0.5 |
| Example 1-4 | C₄H₉(CH₃)₂SiN(CH₃)₂ | 1 | CF₃COOH | 10 | PGMEA | 10 | 20 | <10 | 87 | <10 | <0.5 | <10 | 71 | <10 | <0.5 |
| Example 1-5 | C₄H₉(CH₃)₂SiN(CH₃)₂ | 1 | (CF₃CO)₂O | 10 | PGMEA | 10 | 20 | <10 | 89 | <10 | <0.5 | <10 | 73 | <10 | <0.5 |
| Example 1-6 | C₈H₁₇(CH₃)₂SiN(CH₃)₂ | 1 | CF₃COOH | 10 | PGMEA | 1 | 20 | <10 | 102 | <10 | <0.5 | <10 | 86 | <10 | <0.5 |
| Example 1-7 | C₈H₁₇(CH₃)₂SiN(CH₃)₂ | 3 | CF₃COOH | 3.3 | PGMEA | 1 | 20 | <10 | 102 | <10 | <0.5 | <10 | 87 | <10 | <0.5 |
| Example 1-8 | C₈H₁₇(CH₃)₂SiN(CH₃)₂ | 10 | CF₃COOH | 1 | PGMEA | 1 | 20 | <10 | 104 | <10 | <0.5 | <10 | 89 | <10 | <0.5 |
| Example 1-9 | C₈H₁₇(CH₃)₂SiN(CH₃)₂ | 1 | CF₃COOH | 30 | PGMEA | 1 | 20 | <10 | 103 | <10 | <0.5 | <10 | 85 | <10 | <0.5 |
| Example 1-10 | C₈H₁₇(CH₃)₂SiN(CH₃)₂ | 3 | CF₃COOH | 10 | PGMEA | 1 | 20 | <10 | 103 | <10 | <0.5 | <10 | 87 | <10 | <0.5 |
| Example 1-11 | C₈H₁₇(CH₃)₂SiN(CH₃)₂ | 1 | CF₃COOH | 10 | PGMEA | 10 | 20 | <10 | 101 | <10 | <0.5 | <10 | 91 | <10 | <0.5 |
| Example 1-12 | C₈H₁₇(CH₃)₂SiN(CH₃)₂ | 1 | CF₃COOH | 10 | PGMEA | 1 | 40 | <10 | 101 | <10 | <0.5 | <10 | 90 | <10 | <0.5 |
| Example 1-13 | C₈H₁₇(CH₃)₂SiN(CH₃)₂ | 1 | CF₃COOH | 10 | HFE-7100/PGMEA | 1 | 20 | <10 | 102 | <10 | <0.5 | <10 | 88 | <10 | <0.5 |
| Example 1-14 | C₈H₁₇(CH₃)₂SiN(CH₃)₂ | 1 | CF₃COOH | 10 | CTFP/PGMEA | 1 | 20 | <10 | 100 | <10 | <0.5 | <10 | 86 | <10 | <0.5 |
| Example 1-15 | C₈H₁₇(CH₃)₂SiN(CH₃)₂ | 1 | CF₃COOH | 10 | DCTFP/PGMEA | 1 | 20 | <10 | 102 | <10 | <0.5 | <10 | 88 | <10 | <0.5 |
| Example 1-16 | C₈H₁₇(CH₃)₂SiN(CH₃)₂ | 1 | (CF₃CO)₂O | 10 | PGMEA | 1 | 20 | <10 | 102 | <10 | <0.5 | <10 | 87 | <10 | <0.5 |
| Example 1-17 | C₈H₁₇(CH₃)₂SiN(CH₃)₂ | 3 | (CF₃CO)₂O | 3.3 | PGMEA | 1 | 20 | <10 | 103 | <10 | <0.5 | <10 | 88 | <10 | <0.5 |
| Example 1-18 | C₈H₁₇(CH₃)₂SiN(CH₃)₂ | 10 | (CF₃CO)₂O | 1 | PGMEA | 1 | 20 | <10 | 101 | <10 | <0.5 | <10 | 86 | <10 | <0.5 |
| Example 1-19 | C₈H₁₇(CH₃)₂SiN(CH₃)₂ | 1 | (CF₃CO)₂O | 30 | PGMEA | 1 | 20 | <10 | 103 | <10 | <0.5 | <10 | 87 | <10 | <0.5 |
| Example 1-20 | C₈H₁₇(CH₃)₂SiN(CH₃)₂ | 3 | (CF₃CO)₂O | 10 | PGMEA | 1 | 20 | <10 | 104 | <10 | <0.5 | <10 | 88 | <10 | <0.5 |
| Example 1-21 | C₈H₁₇(CH₃)₂SiN(CH₃)₂ | 1 | (CF₃CO)₂O | 10 | PGMEA | 10 | 40 | <10 | 104 | <10 | <0.5 | <10 | 87 | <10 | <0.5 |
| Example 1-22 | C₈H₁₇(CH₃)₂SiN(CH₃)₂ | 1 | (CF₃CO)₂O | 10 | PGMEA | 1 | 20 | <10 | 102 | <10 | <0.5 | <10 | 85 | <10 | <0.5 |
| Example 1-23 | C₈H₁₇(CH₃)₂SiN(CH₃)₂ | 1 | (CF₃CO)₂O | 10 | HFE-7100/PGMEA | 1 | 20 | <10 | 103 | <10 | <0.5 | <10 | 86 | <10 | <0.5 |
| Example 1-24 | C₈H₁₇(CH₃)₂SiN(CH₃)₂ | 1 | (CF₃CO)₂O | 10 | CTFP/PGMEA | 1 | 20 | <10 | 101 | <10 | <0.5 | <10 | 85 | <10 | <0.5 |
| Example 1-25 | C₈H₁₇(CH₃)₂SiN(CH₃)₂ | 1 | (CF₃CO)₂O | 10 | DCTFP/PGMEA | 1 | 20 | <10 | 102 | <10 | <0.5 | <10 | 87 | <10 | <0.5 |
| Example 1-26 | C₈H₁₇Si[N(CH₃)₂]₃ | 1 | (CF₃CO)₂O | 10 | PGMEA | 1 | 20 | <10 | 93 | <10 | <0.5 | <10 | 87 | <10 | <0.5 |
| Comparative | (CH₃)₃SiCl | 1 | — | — | HFE-7100/PGMEA | 1 | 20 | <10 | 71 | <10 | <0.5 | <10 | 41 | — | — |
| Example 1-1 | | | | | | | | | | | | | | | |
| Comparative | (CH₃)₃SiN(CH₃)₂ | 1 | CF₃COOH | 10 | PGMEA | 1 | 20 | <10 | 91 | <10 | <0.5 | <10 | 60 | — | — |
| Example 1-2 | | | | | | | | | | | | | | | |
| Comparative | [CF₃(CH₂)₂(CH₃)₂Si]₂NH | 1 | CF₃COOH | 10 | PGMEA | 1 | 20 | <10 | 96 | <10 | <0.5 | <10 | 62 | — | — |
| Example 1-3 | | | | | | | | | | | | | | | |

### Examples 1-2 to 1-3

A surface treatment of wafer was conducted upon modifying the organic solvent employed in Example 1-1, followed by evaluation thereof. Results are shown in Table 1. Incidentally, in Table 1, “CTFP/PGMEA” means an organic solvent obtained by using 1-chloro-3,3,3-trifluoropropene (CTFP) instead of HFE-7100 of Example 1-1. “DCTFP/PGMEA” means an organic solvent obtained by using cis-1,2-dichloro-3,3,3-trifluoropropene (DCTFP) instead of HFE-7100 of Example 1-1.

### Example 1-4

The liquid chemical for forming a protective film was produced by using a mixture of; 1 g of butyldimethylsilyl dimethylamine [C₄H₉(CH₃)₂SiN(CH₃)₂] that serves as a protective film forming agent; 98.9 g of PGMEA that serves as an organic solvent; and 0.1 g of trifluoroacetic acid [CF₃COOH] that serves as a catalyst. The amount of the catalyst to be added (hereinafter, referred to as “the catalyst concentration”) was 10 mass % relative to 100 mass % of the total amount of the protective film forming agent. Additionally, the time for immersion of each wafer into the liquid chemical for forming a protective film was 10 minutes. With the exception of the above, all the procedure was the same as that of Example 1-1.

As a result of evaluating the silicon wafer having a silicon oxide film, the contact angle of the wafer after the surface treatment was 87° as shown in Table 1, with which it was confirmed that a water repellency imparting effect was excellently exhibited. Moreover, the contact angle of the wafer after UV irradiation was smaller than 10°, with which it was confirmed that removal of the protective film was achieved. Furthermore, the Ra value of the wafer after UV irradiation was smaller than 0.5 nm, so that it was confirmed that the wafer was not eroded at the time of cleaning and that residues of the water repellent protective film did not remain after UV irradiation.

Additionally, as a result of evaluating the silicon wafer having a silicon nitride film, the contact angle of the wafer after the surface treatment was 71° as shown in Table 1, with which it was confirmed that a water repellency imparting effect was excellently exhibited. Moreover, the contact angle of the wafer after UV irradiation was smaller than 10°, with which it was confirmed that removal of the protective film was achieved. Furthermore, the Ra value of the wafer after UV irradiation was smaller than 0.5 nm, so that it was confirmed that the wafer was not eroded at the time of cleaning and that residues of the water repellent protective film did not remain after UV irradiation.

### Examples 1-5 to 1-26

A surface treatment of wafer was conducted upon modifying the conditions employed in Example 1-4 (concerning the protective film forming agent, the protective film forming agent concentration, the catalyst, the catalyst concentration, the organic solvent, the time for immersion of each wafer into the liquid chemical for forming a protective film, and the temperature of immersion of each wafer into the liquid chemical for forming a protective film), followed by evaluation thereof. Results are shown in Table 1. Incidentally, in Table 1, “C₈H₁₇(CH₃)₂SiN(CH₃)₂” means octyldimethylsilyl dimethylamine. “C₈H₁₇Si[N(CH₃)₂]₃” means octylsilyl trisdimethylamine. “(CF₃CO)₂O” means trifluoroacetic anhydride.

### Comparative Example 1-1

All the procedure was the same as that of Example 1-1 with the exception that 1 g of trimethylchlorosilane [(CH₃)₃SiCl] was used as a protective film forming agent.

As a result of evaluating the silicon wafer having a silicon oxide film, the contact angle of the wafer after the surface treatment was 71° as shown in Table 1, with which it was confirmed that a water repellency imparting effect was excellently exhibited. Moreover, the contact angle of the wafer after UV irradiation was smaller than 10°, with which it was confirmed that removal of the protective film was achieved. Furthermore, the Ra value of the wafer after UV irradiation was smaller than 0.5 nm, so that it was confirmed that the wafer was not eroded at the time of cleaning and that residues of the water repellent protective film did not remain after UV irradiation.

On the other hand, as a result of evaluating the silicon wafer having a silicon nitride film, the contact angle of the wafer after the surface treatment was 41° as shown in Table 1, with which it was confirmed that a water repellency imparting effect was not obtained sufficiently.

### Comparative Example 1-2

All the procedure was the same as that of Example 1-6 with the exception that 1 g of trimethylsilyl dimethylamine [(CH₃)₃SiN(CH₃)₂] was used as a protective film forming agent.

As a result of evaluating the silicon wafer having a silicon oxide film, the contact angle of the wafer after the surface treatment was 91° as shown in Table 1, with which it was confirmed that a water repellency imparting effect was excellently exhibited. Moreover, the contact angle of the wafer after UV irradiation was smaller than 10°, with which it was confirmed that removal of the protective film was achieved. Furthermore, the Ra value of the wafer after UV irradiation was smaller than 0.5 nm, so that it was confirmed that the wafer was not eroded at the time of cleaning and that residues of the water repellent protective film did not remain after UV irradiation.

On the other hand, as a result of evaluating the silicon wafer having a silicon nitride film, the contact angle of the wafer after the surface treatment was 60° as shown in Table 1, with which it was confirmed that a water repellency imparting effect was not obtained sufficiently.

### Comparative Example 1-3

All the procedure was the same as that of Example 1-6 with the exception that 1 g of 1,3-bis(3,3,3-trifluoropropyl)-1,1,3,3-tetramethyldisilazane [[CF₃(CH₂)₂(CH₃)₂Si]₂NH] was used as a protective film forming agent.

As a result of evaluating the silicon wafer having a silicon oxide film, the contact angle of the wafer after the surface treatment was 96° as shown in Table 1, with which it was confirmed that a water repellency imparting effect was excellently exhibited. Moreover, the contact angle of the wafer after UV irradiation was smaller than 10°, with which it was confirmed that removal of the protective film was achieved. Furthermore, the Ra value of the wafer after UV irradiation was smaller than 0.5 nm, so that it was confirmed that the wafer was not eroded at the time of cleaning and that residues of the water repellent protective film did not remain after UV irradiation.

On the other hand, as a result of evaluating the silicon wafer having a silicon nitride film, the contact angle of the wafer after the surface treatment was 62° as shown in Table 1, with which it was confirmed that a water repellency imparting effect was not obtained sufficiently.

Thus, in the compounds of Comparative Examples 1-1 to 1-3, it was possible to obtain a good water repellency imparting effect in the case of the silicon wafer having a silicon oxide film of which surface is rich in hydroxyl groups; however, in the case of the silicon wafer having a silicon nitride film of which surface is poor in hydroxyl groups, the water repellency imparting effect was not sufficiently obtained. Thus, the water repellency imparting effect greatly depended on the number of hydroxyl groups different according to the kind of wafer.

### Example 2

In Example 2, examinations as to treatments on polysilicon were performed. As a wafer in which the surface of polysilicon is smooth, a silicon wafer having a smooth surface was used. A method for evaluating a wafer to which the liquid chemical for forming a protective film of the present invention was supplied is the same as the method employed in Example 1. As a method for evaluating a wafer cleaned with the liquid chemical for forming a water repellent protective film of the present invention, the following evaluations (1) to (3) were performed.

### (1) Evaluation of Contact Angle of Protective Film Formed on Wafer Surface

About 2 μl of pure water was dropped on a surface of a wafer on which a protective film was formed, followed by measuring an angle (the contact angle) formed between the waterdrop and the wafer surface by using a contact angle meter (produced by Kyowa Interface Science Co., Ltd.: CA-X Model). A sample where the contact angle to the protective film was within a range of from 65 to 115° was classified as being acceptable.

### (2) Removability of Protective Film

The sample was irradiated with UV rays from a low-pressure mercury lamp for 1 minute under the following conditions. A sample on which waterdrop had a contact angle of not larger than 10° after the irradiation was regarded as having removed the protective film and classified as being acceptable.
Lamp: PL2003N-10 produced by SEN LIGHTS CORPORATION
Illuminance: 15 mW/cm2 (the distance from the light source to the sample was 10 mm)

### (3) Evaluation of Surface Smoothness of Wafer after Removing Protective Film

The surface was observed by atomic force microscope (produced by Seiko Instruments Inc.: SPI3700, 2.5 micrometer square scan) thereby obtaining a difference ΔRa (nm) in the centerline average surface roughness Ra (nm) of the wafer between before and after the cleaning. Incidentally, “Ra” is a three-dimensionally enlarged one obtained by applying the centerline average roughness defined by JIS B 0601 to a measured surface and is calculated as “an average value of absolute values of difference from standard surface to designated surface” from the following equation.

$$Ra = \frac{1}{{S}_{0}} {\int }_{{Y}_{T}}^{{Y}_{B}} {\int }_{{X}_{L}}^{{X}_{R}} \vert F ( X , Y ) - {Z}_{0} \vert d X d Y$$

where X_{L} and X_{R}, and Y_{B} and Y_{T} represent a measuring range in the X coordinate and the Y coordinate, respectively. S₀ represents an area obtained on the assumption that the measured surface is ideally flat, and is a value obtained by (X_{R}−X_{L})×(Y_{B}−Y_{T}). Additionally, F(X,Y) represents the height at a measured point (X,Y). Z₀ represents the average height within the measured surface.

The Ra value of the wafer surface before the protective film was formed and the Ra value of the wafer surface after the protective film was removed were measured. If a difference between them (ΔRa) was within ±1 nm, the wafer surface was regarded as not having been eroded by the cleaning and regarded as not having left residues of the protective film thereon, and therefore classified as an acceptable one.

### Example 2-1

### (1) Preparation of Liquid Chemical for Forming Water Repellent Protective Film

A liquid chemical for forming a protective film was produced by using: 3 g of octyldimethylsilyl dimethylamine [C₈H₁₇(CH₃)₂SiN(CH₃)₂] that serves as a protective film forming agent; 96.9 g of PGMEA that serves as an organic solvent; and 0.1 g of trifluoroacetic acid [CH₃COOH] that serves as a catalyst.

### (2) Cleaning of Wafer

A smooth silicon wafer was immersed in 1 mass % hydrogen fluoride aqueous solution for 1 minute, and then immersed in pure water for 1 minute as “a cleaning step using a water-based cleaning liquid”. Then, after preparing a mixture in which 28 mass % NH₃aq.:30 mass % H₂O₂aq.:H₂O was 1:1:5 in volume ratio and heating it to a temperature of 70° C., the wafer was immersed therein for 1 minute, and then immersed in pure water for 1 minute. Thereafter, the wafer was immersed in 2-propanol (hereinafter, sometimes referred to as “iPA”) for 1 minute and then immersed in propylene glycol monomethyl ether acetate (hereinafter, sometimes referred to as “PGMEA”) for 1 minute.

### (3) Surface Treatment on Wafer Surface, Using Liquid Chemical for Forming Protective Film

After “(2) Cleaning of Wafer”, the silicon wafer was immersed in the liquid chemical for forming a protective film at 20° C. for 1 minute, the liquid chemical being prepared in “(1) Preparation of Liquid Chemical for forming Water Repellent Protective Film”. Then, the wafer was immersed in iPA for 10 seconds. Finally, the wafer was taken out of iPA, followed by spraying air thereon to remove iPA from the surface.

As a result of evaluating the thus obtained silicon wafer in a manner discussed above a silicon wafer having an initial contact angle of smaller than 10° before the formation of the water repellent protective film had a contact angle of 98° after the formation of the protective film as shown in Table 2, with which it was confirmed that a water repellency imparting effect was excellently exhibited. Moreover, the contact angle of the wafer after UV irradiation was smaller than 10°, with which it was confirmed that removal of the protective film was achieved.

Furthermore, the ΔRa value of the wafer after UV irradiation was within ±0.5 nm, so that it was confirmed that the wafer was not eroded at the time of cleaning and that residues of the protective film did not remain after UV irradiation.

### Examples 2-2 to 2-4

A surface treatment of wafer was conducted upon modifying the conditions employed in Example 2-1 (concerning the catalyst and the time spent for the protective film forming step), followed by evaluation thereof. “(CF₃CO)₂O” means trifluoroacetic anhydride. Results are shown in Table 2.

TABLE 2

| | | Liquid Chemical for Forming Protective Film | | | | |
|---|---|---|---|---|---|---|
| | | Protective | | | | |
| | | Film | | | | |
| | | Forming | | | | |
| | | Agent | | Catalyst | | Treatment |
| | Protective Film | Concentration | | Concentration | Organic | Time |
| | Forming Agent | [mass %] | Catalyst | [mass %] | Solvent | [min] |
| Example 2-1 | C₈H₁₇(CH₃)₂SiN(CH₃)₂ | 3 | CF₃COOH | 3.3 | PGMEA | 1 |
| Example 2-2 | C₈H₁₇(CH₃)₂SiN(CH₃)₂ | 3 | (CF₃CO)₂O | 3.3 | PGMEA | 1 |
| Example 2-3 | C₈H₁₇(CH₃)₂SiN(CH₃)₂ | 3 | CF₃COOH | 3.3 | PGMEA | 10 |
| Example 2-4 | C₈H₁₇(CH₃)₂SiN(CH₃)₂ | 3 | (CF₃CO)₂O | 3.3 | PGMEA | 10 |

| | | Evaluation Results | | | |
|---|---|---|---|---|---|
| | | | Contact | Removability | |
| | | | Angle | of | |
| | | Initial | after | Protective | |
| | Treatment | Contact | Surface | Film | Surface |
| | Temperature | Angle | Treatment | (Contact | Smoothness |
| | [° C.] | [°] | [°] | Angle [°]) | (ΔRa [nm]) |
| Example 2-1 | 20 | <10 | 98 | <10 | <0.5 |
| Example 2-2 | 20 | <10 | 97 | <10 | <0.5 |
| Example 2-3 | 20 | <10 | 102 | <10 | <0.5 |
| Example 2-4 | 20 | <10 | 104 | <10 | <0.5 |

### Example 3

In Example 3, examinations as to treatments on titanium nitride were performed. As a wafer in which the surface of titanium nitride is smooth, there was used “a wafer having a titanium nitride film” where a silicon wafer having a smooth surface has a titanium nitride layer thereon (hereinafter, this wafer is sometimes referred to as “a TiN wafer”). As a method for evaluating a wafer cleaned with the liquid chemical for forming a water repellent protective film of the present invention, the following evaluations (1) to (3) were performed.

### (1) Evaluation of Contact Angle of Protective Film Formed on Wafer Surface

About 2 μl of pure water was dropped on a surface of a wafer on which a protective film was formed, followed by measuring an angle (the contact angle) formed between the waterdrop and the wafer surface by using a contact angle meter (produced by Kyowa Interface Science Co., Ltd.: CA-X Model). A sample where the contact angle to the protective film was within a range of from 65 to 115° was classified as being acceptable.

### (2) Removability of Protective Film

The sample was irradiated with UV rays from a low-pressure mercury lamp for 1 minute under the following conditions. A sample on which waterdrop had a contact angle of not larger than 10° after the irradiation was regarded as having removed the protective film and classified as being acceptable.
Lamp: PL2003N-10 produced by SEN LIGHTS CORPORATION
Illuminance: 15 mW/cm² (the distance from the light source to the sample was 10 mm)

### (3) Evaluation of Surface Smoothness of Wafer after Removing Protective Film

The surface was observed by atomic force microscope (produced by Seiko Instruments Inc.: SPI3700, 2.5 micrometer square scan) thereby obtaining a difference ΔRa (nm) in the centerline average surface roughness Ra (nm) of the wafer between before and after the cleaning. Incidentally, “Ra” is a three-dimensionally enlarged one obtained by applying the centerline average roughness defined by JIS B 0601 to a measured surface and is calculated as “an average value of absolute values of difference from standard surface to designated surface” from the following equation.

$$Ra = \frac{1}{{S}_{0}} {\int }_{{Y}_{T}}^{{Y}_{B}} {\int }_{{X}_{L}}^{{X}_{R}} \vert F ( X , Y ) - {Z}_{0} \vert d X d Y$$

where X_{L} and X_{R}, and Y_{B} and Y_{T} represent a measuring range in the X coordinate and the Y coordinate, respectively. S₀ represents an area obtained on the assumption that the measured surface is ideally flat, and is a value obtained by (X_{R}−X_{L})×(Y_{B}−Y_{T}). Additionally, F(X,Y) represents the height at a measured point (X,Y). Z₀ represents the average height within the measured surface.

The Ra value of the wafer surface before the protective film was formed and the Ra value of the wafer surface after the protective film was removed were measured. If a difference between them (ΔRa) was within ±1 nm, the wafer surface was regarded as not having been eroded by the cleaning and regarded as not having left residues of the protective film thereon, and therefore classified as an acceptable one.

### Example 3-1

### (1) Preparation of Liquid Chemical for Forming Water Repellent Protective Film

A mixture of 10 g of nonafluorohexyldimethylchlorosilane [C₄F₉(CH₂)₂(CH₃)₂SiCl] that serves as a water repellent protective film forming agent and 90 g of hydrofluoroether that serves as an organic solvent (HFE-7100 produced by 3M Limited) was prepared and stirred for about 5 minutes, thereby obtaining a liquid chemical for forming a protective film in which the concentration of a protective film forming agent (hereinafter referred to as “the protective film forming agent concentration”) was 10 mass % relative to the total amount of the liquid chemical for forming a protective film.

### (2) Cleaning of TiN Wafer

A smooth TiN wafer (a silicon wafer having a titanium nitride layer of 50 nm thickness on its surface) was immersed in 1 mass % hydrogen fluoride aqueous solution for 1 minute, and then immersed in pure water for 1 minute as “a cleaning step using a water-based cleaning liquid”. Then, the wafer was immersed in 2-propanol (hereinafter, sometimes referred to as “iPA”) for 1 minute, and then immersed in propylene glycol monomethyl ether acetate (hereinafter, sometimes referred to as “PGMEA”) for 1 minute.

### (3) Surface Treatment on Wafer Surface, Using Liquid Chemical for Forming Protective Film

After “(2) Cleaning of TiN Wafer”, the TiN wafer was immersed in the liquid chemical for forming a protective film at 20° C. for 1 minute, the liquid chemical being prepared in “(1) Preparation of Liquid Chemical for forming Water Repellent Protective Film”. Then, the TiN wafer was immersed in iPA for 10 seconds. Finally, the TiN wafer was taken out of iPA, followed by spraying air thereon to remove iPA from the surface.

As a result of evaluating the thus obtained TiN wafer in a manner discussed above, a wafer having an initial contact angle of smaller than 10° before the formation of the water repellent protective film had a contact angle of 91° after the formation of the protective film as shown in Table 3, with which it was confirmed that a water repellency imparting effect was excellently exhibited. Moreover, the contact angle of the wafer after UV irradiation was smaller than 10°, with which it was confirmed that removal of the protective film was achieved. Furthermore, the ΔRa value of the wafer after UV irradiation was within ±0.5 nm, so that it was confirmed that the wafer was not eroded at the time of cleaning and that residues of the protective film did not remain after UV irradiation.

TABLE 3

| | | Liquid Chemical for Forming Protective Film | | | | |
|---|---|---|---|---|---|---|
| | | Protective | | | | |
| | | Film | | | | |
| | | Forming | | | | |
| | | Agent | | Catalyst | | Treatment |
| | Protective Film | Concentration | | Concentration | Organic | Time |
| | Forming Agent | [mass %] | Catalyst | [mass %] | Solvent | [min] |
| Example 3-1 | C₄F₉(CH₂)₂(CH₃)₂SiCl | 10 | — | — | HFE-7100 | 1 |
| Example 3-2 | C₄F₉(CH₂)₂(CH₃)₂SiCl | 10 | — | — | HFE-7100 | 10 |
| Example 3-3 | C₄H₉(CH₃)₂Si[N(CH₃)₂]₃ | 5 | (CF₃CO)₂O | 3.6 | PGMEA | 1 |
| Example 3-4 | C₄H₉(CH₃)₂Si[N(CH₃)₂]₃ | 5 | (CF₃CO)₂O | 3.6 | PGMEA | 10 |
| Compara- | (CH₃)₃SiN(CH₃)₂ | 10 | — | — | PGMEA | 1 |
| tive | | | | | | |
| Example 3-1 | | | | | | |

| | | Evaluation Results | | | |
|---|---|---|---|---|---|
| | | | Contact | Removability | |
| | | | Angle | of | |
| | | Initial | after | Protective | |
| | Treatment | Contact | Surface | Film | Surface |
| | Temperature | Angle | Treatment | (Contact | Smoothness |
| | [° C.] | [°] | [°] | Angle [°]) | (ΔRa [nm]) |
| Example 3-1 | 20 | <10 | 91 | <10 | <0.5 |
| Example 3-2 | 20 | <10 | 97 | <10 | <0.5 |
| Example 3-3 | 20 | <10 | 92 | <10 | <0.5 |
| Example 3-4 | 20 | <10 | 93 | <10 | <0.5 |
| Comparative | 20 | <10 | 18 | — | — |
| Example 3-1 | | | | | |

### Examples 3-2 to 3-4

A surface treatment of wafer was conducted upon modifying the conditions employed in Example 3-1 (concerning the protective film forming agent, the organic solvent, the protective film forming agent concentration, the catalyst, and the time spent for the protective film forming step), followed by evaluation thereof. Results are shown in Table 3. Incidentally, the concentration of the catalyst is a concentration expressed by mass % relative to 100 mass % of the total amount of the protective film forming agent.

### Comparative Example 3-1

All the procedure was the same as that of Example 3-1 with the exception that a mixture of 10 g of N,N-dimethylaminotrimethylsilane [(CH₃)₃SiN(CH₃)₂] and a 90 g of PGMEA was used as the liquid chemical for forming a protective film. As a result, the contact angle of the TiN wafer after the surface treatment was 18° as shown in Table 3, with which it was confirmed that a water repellency imparting effect was not exhibited.

### INDUSTRIAL APPLICABILITY

A protective film forming agent, a liquid chemical for forming a protective film that contains the agent, and a method for cleaning wafers by using the liquid chemical, of the present invention can reduce modifications of conditions of surface cleaning made according to the kind of wafers and can reduce additional steps in the field of integrated circuits of electronic industry, and therefore contribute to the improvement of the production efficiency. In the case of handling a couple of kinds of wafers, a particularly efficient production is possible.

### EXPLANATION OF REFERENCE NUMERALS

1 Wafer
2 Uneven pattern on a wafer surface
3 Projected portions of the pattern
4 Recessed portions of the pattern
5 Width of the recessed portions
6 Height of the projected portions
7 Width of the projected portions
8 Liquid chemical for forming a water repellent protective film, retained in the recessed portions 4
9 Liquid retained in the recessed portions 4
10 Water repellent protective film

1. A water repellent protective film forming agent which is able to form a protective film on a wafer that has an uneven pattern at its surface, the protective film being formed at least on surfaces of recessed portions of the wafer at the time of cleaning the wafer, the wafer being a wafer that contains a material including silicon element at least at the surfaces of the recessed portions of the uneven pattern or a wafer that contains at least one kind of material selected from the group consisting of titanium, titanium nitride, tungsten, aluminum, copper, tin, tantalum nitride and ruthenium at least at a part of the surfaces of the recessed portions of the uneven pattern, the agent comprising a silicon compound represented by the following general formula [1]:
R¹ₐSiX₄₋ₐ [1]
wherein
R¹ mutually independently represents a hydrogen group or a C₁-C₁₈ hydrocarbon group which is unsubstituted or substituted with halogen atom, and the total number of carbons in mutually independent R¹ is not smaller than 6;
X mutually independently represents at least one group selected from the group consisting of monovalent functional groups of which element to be bonded to the silicon element is nitrogen; monovalent functional groups of which element to be bonded to the silicon element is oxygen; and halogen groups; and
a is an integer of from 1 to 3.

2. A water repellent protective film forming agent which is able to form a protective film on a wafer that has an uneven pattern at its surface, the protective film being formed at least on surfaces of recessed portions of the wafer at the time of cleaning the wafer, the wafer being a wafer that contains silicon nitride at least at the surfaces of the recessed portions of the uneven pattern, the agent comprising a silicon compound represented by the following general formula [1]
R¹ₐSiX₄₋ₐ [1]
wherein
R¹ mutually independently represents a hydrogen group or a C₁-C₁₈ hydrocarbon group which is unsubstituted or substituted with halogen atom, and the total number of carbons in mutually independent R¹ is not smaller than 6;
X mutually independently represents at least one group selected from the group consisting of monovalent functional groups of which element to be bonded to the silicon element is nitrogen; monovalent functional groups of which element to be bonded to the silicon element is oxygen; and halogen groups; and
a is an integer of from 1 to 3.

3. A water repellent protective film forming agent which is able to form a protective film on a wafer that has an uneven pattern at its surface, the protective film being formed at least on surfaces of recessed portions of the wafer at the time of cleaning the wafer, the wafer being a wafer that contains at least one kind of material selected from the group consisting of titanium, titanium nitride, tungsten, aluminum, copper, tin, tantalum nitride and ruthenium at least at the surfaces of the recessed portions of the uneven pattern, the agent comprising a silicon compound represented by the following general formula [1];
R¹ₐSiX₄₋ₐ [1]
wherein
R¹ mutually independently represents a hydrogen group or a C₁-C₁₈ hydrocarbon group which is unsubstituted or substituted with halogen atom, and the total number of carbons in mutually independent R¹ is not smaller than 6;
X mutually independently represents at least one group selected from the group consisting of: monovalent functional groups of which element to be bonded to the silicon element is nitrogen; monovalent functional groups of which element to be bonded to the silicon element is oxygen; and halogen groups; and
a is an integer of from 1 to 3.

4. A water repellent protective film forming agent as claimed in claim 1, wherein the silicon compound represented by the general formula [1] is represented by the following general formula [4]:
R³ₐR⁴_{b}SiX_{4-a-b} [4]
wherein R³ mutually independently represents a C₁-C₁₈ hydrocarbon group where one or more hydrogen elements are substituted with a fluorine element(s);
R⁴ mutually independently represents a hydrogen group or a C₁-C₁₈ hydrocarbon group;
the total number of carbons in R³ and R⁴ in the general formula [4] is not smaller than 6;
X mutually independently represents at least one group selected from the group consisting of: monovalent functional groups of which element to be bonded to the silicon element is nitrogen; monovalent functional groups of which element to be bonded to the silicon element is oxygen; and halogen groups;
a is an integer of from 1 to 3;
b is an integer of from 0 to 2; and
the total of a and b is 1 to 3.

5. A water repellent protective film forming agent as claimed in claim 1, wherein the silicon compound represented by the general formula [1] is represented by the following general formula [2]:
R¹₃SiX [2]
wherein both of R¹ and X are identical with those of the general formula [1].

6. A water repellent protective film forming agent as claimed in claim 1, wherein the silicon compound represented by the general formula [1] is represented by the following general formula [3]:
R²(CH₃)₂SiX [3]
wherein R² represents a C₄-C₁₈ hydrocarbon group which is unsubstituted or substituted with halogen atom; and
X is identical with that of the general formula [1].

7. A water repellent protective film forming agent as claimed in claim 1, wherein R¹ in the silicon compound includes five or more fluorine atoms.

8. A liquid chemical for forming a water repellent protective film, comprising a water repellent protective film forming agent as claimed in claim 1.

9. A liquid chemical for forming a water repellent protective film, as claimed in claim 8, further comprising acid.

10. A liquid chemical for forming a water repellent protective film, as claimed in claim 8, wherein the content of the water repellent protective film forming agent relative to 100 mass % of the total amount of the liquid chemical for forming a water repellent protective film is 0.1 to 50 mass %.

11. A method for cleaning a wafer that has an uneven pattern at its surface, the wafer being a wafer that contains a material including silicon element at least at surfaces of recessed portions of the uneven pattern or a wafer that contains at least one kind of material selected from the group consisting of titanium, titanium nitride, tungsten, aluminum, copper, tin, tantalum nitride and ruthenium at least at a part of the surfaces of the recessed portions of the uneven pattern, the method comprising the following steps of:
a cleaning step using a water-based cleaning liquid, where the surface of the wafer is cleaned with a water-based cleaning liquid;
a water repellent protective film forming step where a liquid chemical for forming a water repellent protective film is retained at least in the recessed portions of the wafer thereby forming a water repellent protective film on the surfaces of the recessed portions;
a liquid removal step where a liquid on the surface of the wafer is removed; and
a water repellent protective film removal step where the water repellent protective film is removed from the surfaces of the recessed portions,
wherein a liquid chemical for forming a water repellent protective film, as claimed in claim 8 is used in the water repellent protective film forming step.

12. A method for cleaning a wafer, as claimed in claim 11, wherein the wafer is a wafer that contains silicon nitride at least at the surfaces of the recessed portions of the uneven pattern.

13. A method for cleaning a wafer, as claimed in claim 11, wherein the wafer is a wafer that contains at least one kind of material selected from the group consisting of titanium, titanium nitride, tungsten, aluminum, copper, tin, tantalum nitride and ruthenium at least at the surfaces of the recessed portions of the uneven pattern.

14. A method for cleaning a wafer, as claimed in claim 11, wherein the water repellent protective film removal step is performed by at least one treatment method selected from the group consisting of: irradiating the surface of the wafer with light; heating the wafer; irradiating the surface of the wafer with plasma; exposing the surface of the wafer to ozone; and subjecting the wafer to corona discharge.

15. A water repellent protective film forming agent as claimed in claim 4, wherein R³ in the silicon compound includes five or more fluorine atoms.

16. A water repellent protective film forming agent as claimed in claim 6, wherein R² in the silicon compound includes five or more fluorine atoms.
